(19) United States
(12) Patent Application Publication
(10) Pub. No.: US 2023/0396180 A1
(43) Pub. Date: Dec. 7, 2023

(54) INTEGRATED TRANSFORMERS FOR HIGH CURRENT CONVERTERS

(71) Applicant: VIRGINIA TECH INTELLECTUAL PROPERTIES, INC., Blacksburg, VA (US)

(72) Inventors: Xin Lou, Blacksburg, VA (US); Qiang Li, Blacksburg, VA (US)

(21) Appl. No.: 18/328,372

(22) Filed: Jun. 2, 2023

Related U.S. Application Data
(60) Provisional application No. 63/365,811, filed on Jun. 3, 2022.

(51) Int. Cl. H02M 3/335; H01F 27/38; H02M 1/00; H01F 3/14; H01F 27/28

(52) U.S. Cl. CPC H02M 3/33592; H01F 27/38; H02M 1/0064; H01F 3/14; H01F 27/2804; H01F 2027/2819

(57) ABSTRACT

Power converters with current doubler rectifier output stages, current doubler rectifier output stages, and integrated transformers for current doubler rectifier output stages and related output stages are described. In one example, a power converter includes a switched bridged input stage and a current doubler rectifier output stage comprising an integrated transformer. The integrated transformer of the current doubler rectifier output stage includes magnetic cores. A primary winding and a secondary winding of the integrated transformer extend around each of the plurality of magnetic cores, and the integrated transformer further includes a coupling winding that extends around each of the plurality of magnetic cores to provide magnetic integration among the plurality of magnetic cores through an electrical coupling. The current doubler rectifier output stage relies upon magnetizing inductance of the integrated transformer to realize the function of inductors, and the integrated transformer current doubler rectifier does not include separate inductors.

### CROSS-REFERENCE TO RELATED APPLICATIONS

This application claims priority to and the benefit of U.S. Provisional Patent Application No. 63/365,811, filed Jun. 3, 2022, titled “INTEGRATED TRANSFORMER AND COUPLED INDUCTORS FOR HIGH CURRENT CONVERTERS,” the entire contents of which is hereby incorporated herein by reference.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Efficient power management solutions are particularly needed in the fields of computing and networking systems, such as in data centers and related computing environments, due to the rapid increase of power consumption by these computing environments. High step-down voltage ratios are relied upon in many computing and networking systems. The LLC resonant converter is one type of power converter that can be used to achieve high step-down voltage ratios, although a number of other types of converters are known. The LLC resonant converter relies on the change of switching frequency to regulate output voltage. The LLC resonant converter is not particularly suitable for applications where wide voltage ranges or fast transient responses are required, such as in 48V to 1V DC-to-DC voltage regulators.

### SUMMARY

Power converters with current doubler rectifier output stages, current doubler rectifier output stages, and integrated transformers for current doubler rectifier output stages and related output stages are described. In one example, a power converter includes a switched bridged input stage and a current doubler rectifier output stage comprising an integrated transformer. The integrated transformer of the current doubler rectifier output stage includes magnetic cores. A primary winding and a secondary winding of the integrated transformer extend around each of the plurality of magnetic cores, and the integrated transformer further includes a coupling winding that extends around each of the plurality of magnetic cores to provide magnetic integration among the plurality of magnetic cores through an electrical coupling. The current doubler rectifier output stage relies upon magnetizing inductance of the integrated transformer to realize the function of inductors, and the integrated transformer current doubler rectifier does not include separate inductors.

In another embodiment, a current doubler rectifier includes an integrated transformer and a coupling inductor. The integrated transformer includes a plurality of magnetic cores. A primary winding and a secondary winding of the integrated transformer extend around each of the plurality of magnetic cores, and the integrated transformer further includes a coupling winding that extends around each of the plurality of magnetic cores to provide magnetic integration among the plurality of magnetic cores through an electrical coupling. The coupling inductor is electrically coupled with the coupling winding to set a coupling coefficient among the plurality of magnetic cores.

In another embodiment, a power converter includes a switched bridged input stage and a current doubler rectifier output stage. The current doubler rectifier output stage includes an integrated transformer. The integrated transformer includes a magnetic core. The magnetic core includes two twisted central legs, and a primary winding and a secondary winding of the integrated transformer extend around the two twisted central legs.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates an example power converter with a current doubler rectifier and a half bridge at the primary side according to various aspects of the present disclosure.

FIG. 1B illustrates another example power converter with a current doubler rectifier and a full bridge at the primary side according to various aspects of the present disclosure.

FIG. 2 illustrates an example current doubler rectifier with an integrated transformer according to various aspects of the present disclosure.

FIG. 3A illustrates a top perspective view of an example integrated transformer according to various aspects of the present disclosure.

FIG. 3B illustrates a bottom perspective view of the example integrated transformer shown in FIG. 3A according to various aspects of the present disclosure.

FIG. 3C illustrates the primary and secondary windings of the integrated transformer shown in FIGS. 3A and 3B, with the core omitted, according to various aspects of the present disclosure.

FIG. 3D illustrates the core of the integrated transformer shown in FIGS. 3A and 3B, with the windings omitted, according to various aspects of the present disclosure.

FIG. 4A illustrates a top perspective view of example primary and secondary windings, which can be interleaved, for use in the integrated transformers according to various aspects of the present disclosure.

FIG. 4B illustrates a top perspective view of the primary and secondary windings shown in FIG. 4A, interleaved together, according to various aspects of the present disclosure.

FIG. 4C illustrates a bottom perspective view of the primary and secondary windings shown in FIG. 4A, interleaved together, according to various aspects of the present disclosure.

FIG. 5 illustrates another example current doubler rectifier with an integrated transformer according to various aspects of the present disclosure.

FIG. 6A illustrates a top perspective view of an example integrated transformer according to various aspects of the present disclosure.

FIG. 6B illustrates a bottom perspective view of the example integrated transformer shown in FIG. 6A according to various aspects of the present disclosure.

FIG. 6C illustrates the primary and secondary windings of the integrated transformer shown in FIGS. 6A and 6B, with the core omitted, according to various aspects of the present disclosure.

FIG. 6D illustrates the core of the integrated transformer shown in FIGS. 6A and 6B, with the windings omitted, according to various aspects of the present disclosure.

FIG. 7 illustrates an example current doubler rectifier with an integrated transformer including a coupling winding according to various aspects of the present disclosure.

FIG. 8A illustrates a top perspective view of an example integrated transformer with a coupling winding according to various aspects of the present disclosure.

FIG. 8B illustrates a bottom perspective view of the example integrated transformer shown in FIG. 8A according to various aspects of the present disclosure.

FIG. 8C illustrates the primary, secondary, and coupling windings of the integrated transformer shown in FIGS. 8A and 8B, with the core omitted, according to various aspects of the present disclosure.

FIG. 8D illustrates the core of the integrated transformer shown in FIGS. 8A and 8B, with the windings omitted, according to various aspects of the present disclosure.

FIG. 9 illustrates another example current doubler rectifier with an integrated transformer including a coupling winding according to various aspects of the present disclosure.

FIG. 10 illustrates an exploded perspective view of an example integrated transformer with a coupling winding according to various aspects of the present disclosure.

FIG. 11A illustrates a perspective view of an example integrated transformer with a coupling winding according to various aspects of the present disclosure.

FIG. 11B illustrates a bottom view of the integrated transformer shown in FIG. 11A according to various aspects of the present disclosure.

FIG. 12 illustrates an example power converter with a current trippler rectifier according to various aspects of the present disclosure.

FIG. 13A illustrates an integrated transformer for a current trippler rectifier according to various aspects of the present disclosure.

FIG. 13B illustrates another integrated transformer for a current trippler rectifier according to various aspects of the present disclosure.

FIG. 13C illustrates another integrated transformer for a current trippler rectifier according to various aspects of the present disclosure.

FIG. 14A illustrates an example of a planar integrated transformer with a coupling winding according to various aspects of the present disclosure.

FIG. 14B illustrates an exploded view of the integrated transformer shown in FIG. 14A according to various aspects of the present disclosure.

FIG. 15A illustrates an example of a planar integrated transformer with a coupling winding according to various aspects of the present disclosure.

FIG. 15B illustrates an exploded view of the integrated transformer shown in FIG. 15A according to various aspects of the present disclosure.

FIG. 16A illustrates an example of a planar integrated transformer with a coupling winding according to various aspects of the present disclosure.

FIG. 16B illustrates an exploded view of the integrated transformer shown in FIG. 16A according to various aspects of the present disclosure.

FIG. 17A illustrates an example of a planar integrated transformer with a coupling winding according to various aspects of the present disclosure.

FIG. 17B illustrates an exploded view of the integrated transformer shown in FIG. 17A according to various aspects of the present disclosure.

FIG. 18 illustrates an example of a planar integrated transformer with a coupling winding according to various aspects of the present disclosure.

FIG. 19 illustrates an example of a planar integrated transformer with a coupling winding according to various aspects of the present disclosure.

### DETAILED DESCRIPTION

As noted above, LLC resonant converters can be used to achieve high step-down voltage ratios. However, LLC resonant converters are not particularly suitable for applications where wide output voltage ranges, fast transient responses, or both wide voltage ranges and fast transient responses are required, such as in 48V to 1V DC-to-DC voltage converters and regulators. Some DC-to-DC voltage converters and regulators include two-stage solutions. The first stage is implemented as an LLC resonant converter or a switched tank converter, which is unregulated, and the second stage is implemented as one or more multiphase buck converters. A single stage 48V to 1V regulator would be preferred, however, to improve efficiency and power density.

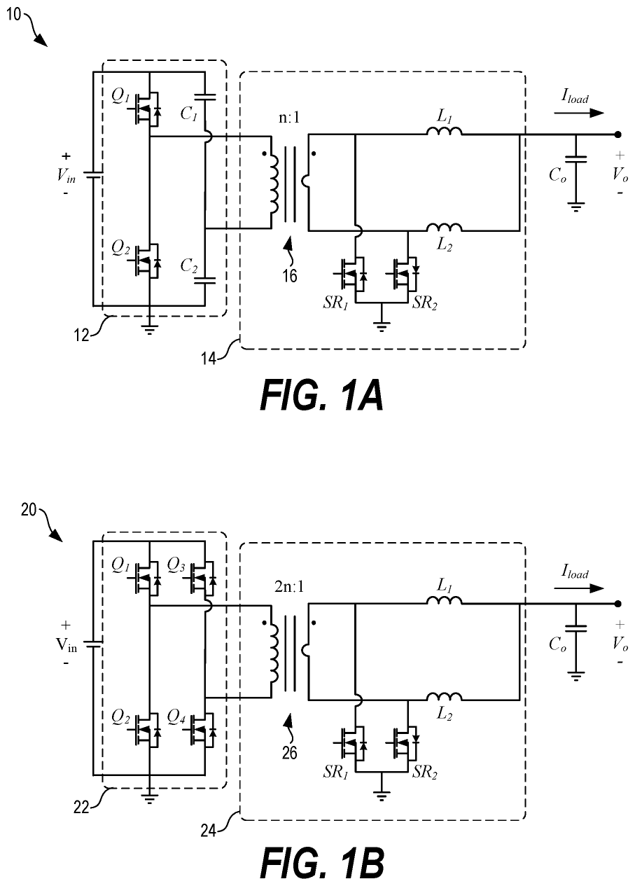

The current doubler rectifier is one type of output stage that can be relied upon in power converters. FIG. 1A illustrates an example power converter 10 according to various aspects of the present disclosure. The power converter 10 is illustrated as a representative example of a power conversion system including a current doubler rectifier output stage. In some cases, the power converter 10 can include other components that are not illustrated in FIG. 1A, such as a controller, additional blocking, bulk, or other capacitors, additional inductors, rectifiers, or switching transistors, and other components. The power converter 10 can be implemented using a combination of integrated and discrete circuit components, for example, on one or more printed circuit boards (PCBs). The concepts of integrated transformer and coupled inductors, as described herein, can be applied in the power converter 10, as one example, among other types of power converters.

As shown in FIG. 1A, the power converter 10 includes a half bridge inverter 12 and a current doubler rectifier 14. The current doubler rectifier 14 operates as the output stage of the power converter 10. An input voltage Vᵢₙ is applied at the half bridge inverter 12, as an input to the power converter 10. An output voltage Vₒ is generated at an output of the current doubler rectifier 14 and the power converter 10.

The half bridge inverter 12 includes switching transistors Q₁ and Q₂ and blocking capacitors C₁ and C₂, among possibly other components. The current doubler rectifier 14 includes a transformer 16, inductors L₁ and L₂, and synchronous rectifiers SR₁ and SR₂, among possibly other components. The power converter 10 also includes an output capacitor Cₒ in the example shown. The switching transistors Q₁ and Q₂ of the half bridge inverter 12 are electrically coupled at one side of a primary winding of the transformer 16 of the current doubler rectifier 14. The blocking capacitors C₁ and C₂ are electrically coupled at another side of the primary winding of the transformer 16. The switching transistors Q₁ and Q₂ of the half bridge inverter 12 can be operated (e.g., switched on and off) by control signals (e.g., gate control signals) provided from a controller (not shown). As one example, the switching transistors Q₁ and Q₂ can be operated by pulse width modulation (PWM) control signals generated by a controller. Based on the switching control, the switching transistors Q₁ and Q₂ can couple the input voltage Vᵢₙ across the primary winding of the transformer 16 and, alternately, discharge or couple the primary winding of the transformer 16 to ground.

As shown in FIG. 1A, the current doubler rectifier 14 relies upon a transformer 16 and two inductors L₁ and L₂. The use of the transformer 16 and separate inductors L₁ and L₂ leads to increased costs for the power converter 10, as compared to other designs described below. The separate transformer and inductor magnetics in the power converter 10 can also lead to reduced power density and power loss as compared to other designs, including the integrated transformer designs described below.

FIG. 1B illustrates another example power converter 20 according to various aspects of the present disclosure. The power converter 20 is illustrated as another example of a power conversion system that can incorporate a current doubler rectifier. In some cases, the power converter 20 can include other components that are not illustrated in FIG. 1C, such as a controller, additional blocking, bulk, or other capacitors, additional inductors, rectifiers, or switching transistors, and other components. The power converter 20 can be implemented using a combination of integrated and discrete circuit components, for example, on one or more PCBs. The concepts of integrated transformer and coupled inductors, as described herein, can be applied in the power converter 20, as one example, among other types of power converters.

As shown in FIG. 1B, the power converter 20 includes a full bridge inverter 22 and a current doubler rectifier 24. The current doubler rectifier 24 operates as the output stage of the power converter 20. An input voltage Vᵢₙ is applied at the full bridge inverter 22, as an input to the power converter 20. An output voltage Vₒ is generated at an output of the current doubler rectifier 24 and the power converter 20.

The full bridge inverter 22 includes switching transistors Q₁-Q₄, among possibly other components. The current doubler rectifier 24 includes a transformer 26, inductors L₁ and L₂, and synchronous rectifiers SR₁ and SR₂, among possibly other components. The power converter 20 also includes an output capacitor Cₒ in the example shown. The switching transistors Q₁ and Q₂ of the full bridge inverter 22 are electrically coupled at one side of a primary winding of the transformer 26 of the current doubler rectifier 24. The switching transistors Q₃ and Q₄ of the full bridge inverter 22 are electrically coupled another side of a primary winding of the transformer 26. The switching transistors Q₁-Q₄ of the full bridge inverter 22 can be operated (e.g., switched on and off) by control signals provided from a controller (not shown). As one example, the switching transistors Q₁-Q₄ can be operated by PWM control signals generated by a controller. Based on the switching control, the switching transistors Q₁-Q₄ can couple the input voltage Vᵢₙ across the primary winding of the transformer 26.

As shown in FIG. 1B, the current doubler rectifier 24 relies upon a transformer 26 and two inductors L₁ and L₂. The use of the transformer 26 and separate inductors L₁ and L₂ leads to increased costs for the power converter 20, as compared to other designs. The separate transformer and inductor magnetics in the power converter 20 can also lead to reduced power density and power loss as compared to other designs, including the integrated transformers designs described below.

Some solutions have been proposed to integrate the transformer and separate inductors in current doubler rectifiers, such as in the current doubler rectifiers 14 and 24 of the power converters 10 and 20 shown in FIGS. 1A and 1B. For example, solutions have been proposed to combine the transformer 16 and the two inductors L₁ and L₂ of the power converter 10 into a single integrated component. Similar solutions have been proposed to combine the transformer 26 and the two inductors L₁ and L₂ of the power converter 20 into a single integrated component. A proposed transformer can include an EI or EE core, a primary winding on the center leg of the core, and two secondary windings on the outer legs of the core. The magnetizing inductance on the secondary side of the transformer can be utilized as the inductors of a current doubler rectifier. The structure offers one way to integrate or combine three magnetic components together. This solution suffers from a relatively high leakage inductance, however, because the primary and secondary windings are placed at different core legs.

In another proposed transformer, the primary winding is split and wound around the two outer legs of an EI or EE core. The secondary windings are also wound around the two outer legs of the core, and the primary and secondary windings can be interleaved in this configuration. Better magnetic coupling and less leakage inductance can be achieved using this design, because both the primary and secondary windings are wound on the same legs of the core. Additionally, interleaved wire windings can be used to minimize leakage inductance. The two inductors are also negatively coupled, which reduces core loss in the center leg of the core and creates non-linear inductors. However, the power consumption of modern microprocessors is increasing significantly, and two or more (e.g., “multiphase”) current doubler rectifiers may be needed in many cases to satisfy the power consumption demands of the processors. The proposed solutions for integrated transformer and inductor components used with power converters including current doubler rectifiers as output stages have not been extended to use with multiphase power converters including current doubler rectifiers. The proposals also do not provide a solution for magnetic coupling among separate magnetic cores, which may be needed for multiphase current doubler rectifiers.

The embodiments described herein are directed to power converters with current doubler rectifier output stages, current doubler rectifier output stages, multiphase current doubler rectifier output stages, and integrated transformers for current doubler rectifier output stages and related output stages. In one example, a power converter includes a switched bridged input stage and a current doubler rectifier output stage comprising an integrated transformer. The integrated transformer of the current doubler rectifier output stage includes magnetic cores. A primary winding and a secondary winding of the integrated transformer extend around each of the plurality of magnetic cores, and the integrated transformer further includes a coupling winding that extends around each of the plurality of magnetic cores to provide magnetic integration among the plurality of magnetic cores through an electrical coupling. The current doubler rectifier output stage relies upon magnetizing inductance of the integrated transformer to realize the function of inductors, and the integrated transformer current doubler rectifier does not include separate inductors.

The integrated transformers described herein can improve power density in power converters including current doubler rectifiers. In addition, the concepts of magnetic or electrical coupling are used in the integrated transformers, either through the use of coupling windings or magnetic cores including twisted central legs. With the proposed integrated transformer structures, the efficiency and power density are improved while maintaining fast transient responses. In addition, techniques for overlapping or interleaving the primary and secondary windings in the integrated transformers are proposed to reduce leakage inductance and improve efficiency and reduce EMI issues.

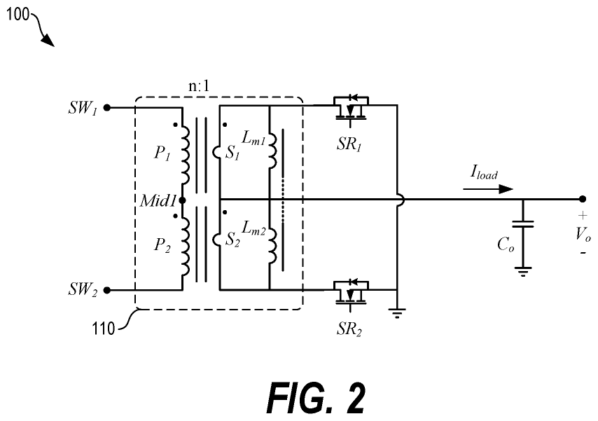

FIG. 2 illustrates an example current doubler rectifier 100 according to various aspects of the present disclosure. The current doubler rectifier 100 includes an integrated transformer 110, synchronous rectifiers SR₁ and SR₂, and an output capacitor Cₒ, among possibly other components. In some cases, the current doubler rectifier 100 can include other components that are not illustrated in FIG. 2, such as a controller, additional blocking, bulk, or other capacitors, additional inductors, rectifiers, or switching transistors, and other components. The current doubler rectifier 100 can be implemented using a combination of integrated and discrete circuit components, for example, on one or more PCBs.

The current doubler rectifier 100 can be relied upon as the output stage of a power converter. As examples, the current doubler rectifier 100 can be relied upon as the output stage of the power converters 10 and 20 shown in FIGS. 1A and 1B. Thus, a half bridge inverter, a full bridge inverter, or related inverter circuit topology can be relied upon as an input to the current doubler rectifier 100 and electrically coupled between the SW₁ and SW₂ input nodes of the current doubler rectifier 100.

The current doubler rectifier 100 does not include a transformer and inductors that are separate from the transformer. The current doubler rectifier 14 shown in FIG. 1A, for example, includes a transformer 16 and two separate inductors L₁ and L₂. However, the current doubler rectifier 100 shown in FIG. 2 includes a single integrated transformer 110. The integrated transformer 110 acts a transformer in the current doubler rectifier 100. Additionally, magnetization inductances in the integrated transformer 110 act as inductors for the current doubler rectifier 100. As shown in FIG. 2, the integrated transformer 110 includes a first primary winding P₁ and a second primary winding P₂ (collectively “primary winding”). The integrated transformer 110 also includes a first secondary winding S₁ and a second secondary winding S₂ (collectively “secondary winding”). The integrated transformer 110 also includes a magnetic core, which can be embodied as one or more core components, and is described in further detail below. Magnetization inductances in the integrated transformer 110, denoted as Lₘ₁ and Lₘ₂ in FIG. 2, operate as the inductors in the current doubler rectifier 100, similar to the inductors L₁ and L₂ shown in FIGS. 1A and 1B. By using the magnetization inductances in the integrated transformer 110, the current doubler rectifier 100 does not include separate inductors (e.g., the separate inductors L₁ and L₂ shown in FIGS. 1A and 1B).

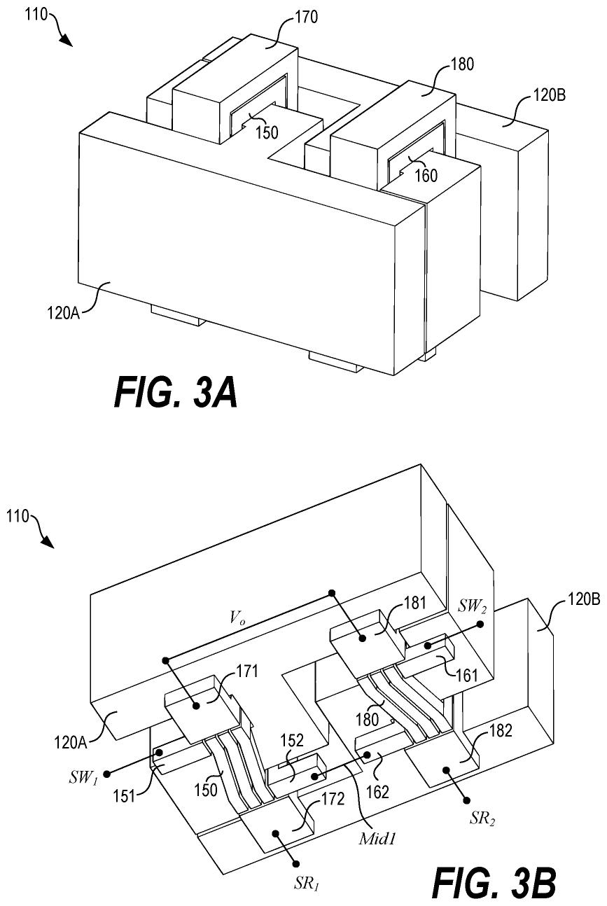

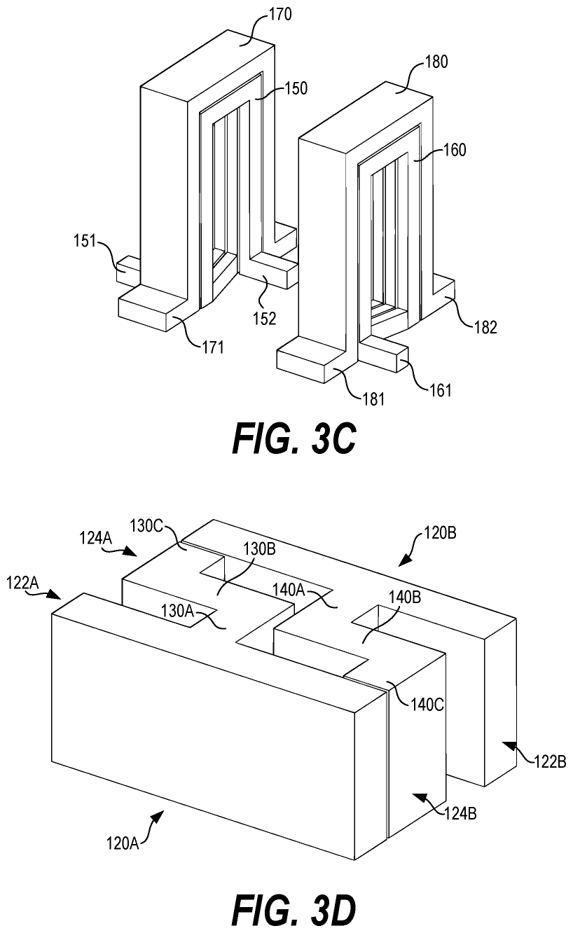

The structure of the integrated transformer 110 is different from other types of integrated magnetic structures used in current doubler rectifiers and offers a reduced size or footprint as compared to other designs. FIG. 3A illustrates a top perspective view of the integrated transformer 110, FIG. 3B illustrates a bottom perspective view of the integrated transformer 110, FIG. 3C illustrates the primary and secondary windings of the integrated transformer 110, with the core omitted, and FIG. 3D illustrates the core of the integrated transformer 110, with the windings omitted. Referring among FIGS. 3A-3D, the integrated transformer 110 includes a core having a first core component 120A and a second core component 120B (collectively “core 120”), a first primary winding 150 and a second primary winding 160 (collectively “primary winding”), and a first secondary winding 170 and a second secondary winding 180 (collectively “secondary winding”).

The first primary winding 150 in FIGS. 3A-3D corresponds to the first primary winding P₁ shown in FIG. 2. The second primary winding 160 in FIGS. 3A-3D corresponds to the second primary winding P₂ shown in FIG. 2. The first secondary winding 170 in FIGS. 3A-3D corresponds to the first secondary winding S₁ shown in FIG. 2. The second secondary winding 180 in FIGS. 3A-3D corresponds to the second secondary winding S₂ shown in FIG. 2. In the example shown, the first primary winding 150 and the second primary winding 160 each include four turns, and the first secondary winding 170 and the second secondary winding 180 each include a single turn. In other examples, the first primary winding 150 and the second primary winding 160 can include other numbers of turns. Additionally, the first secondary winding 170 and the second secondary winding 180 can include other numbers of turns.

The windings 150, 160, 170, and 180 of the integrated transformer 110 can be embodied as conductive windings formed from a conductive material, such as copper, for example. In one example, the windings 150, 160, 170, and 180 can be embodied as copper bar windings, although magnet wire, Litz wire, and other types of conductive wires can be relied upon for the windings 150, 160, 170, and 180. In some cases, the use of Litz wire can be preferred for reduced AC loss, reduced internal resistance, or other factors. If the windings 150, 160, 170, and 180 are implemented as wires (e.g., rather than copper bar windings) the windings 150, 160, 170, and 180 can be wound around bobbins and inserted into the core 120 of the integrated transformer 110.

The core 120 of the integrated transformer 110 can be embodied as a material of high magnetic permeability, such as a ferromagnetic material like iron, laminated silicon steel, laminated iron sheets, or other solid or laminated ferromagnetic ceramic, metal, metal alloy, or related material(s). As best shown in FIG. 3D, the core 120 is different than the typical “I,” “C,” “U,” “E,” and planar “E,” “I,” and related cores. Notably, both the first core component 120A and a second core component 120B include a twisted or turned central leg.

As shown in FIG. 3D, the first core component 120A includes a back segment 122A and a twisted central leg 124A. The twisted central leg 124A includes a first central segment 130A that extends perpendicular to the back segment 122A, a second central segment 130B that extends parallel to the back segment 122A, and a third central segment 130C that extends perpendicular to the back segment 122A. The first central segment 130A and the third central segment 130C extend parallel to each other and are connected by the second central segment 130B.

The second core component 120B also includes a back segment 122B and a twisted central leg 124B, similar to the first core component 120A. The twisted central leg 124B includes a first central segment 140A that extends perpendicular to the back segment 122B, a second central segment 140B that extends parallel to the back segment 122B, and a third central segment 140C that extends perpendicular to the back segment 122B. In the arrangement of the core 120 shown in FIG. 3C, the second core component 120B is rotated 180 degrees as compared to the first core component 120A.

The first core component 120A and the second core component 120B can be positioned in the integrated transformer 110, in one example, such that no or substantially no air gap exists between an end surface of the third central segment 130C of the first core component 120A and a side surface of the back segment 122B of the second core component 120B. Additionally, no or substantially no air gap can exist between an end surface of the third central segment 140C of the second core component 220A and a side surface of the back segment 122A of the first core component 120A. In other cases, air gaps of particular sizes or dimensions can be relied upon to tailor the amount of magnetic coupling in the integrated transformer 110. In the integrated transformer 110, the windings 150 and 170 extend around the second central segment 130B of the first core component 120A, and the windings 160 and 180 extend around the second central segment 140B of the second core component 120B.

The integrated transformer 110 can be mounted to a PCB, in one example, and the ends of the windings 150, 160, 170, and 180 can be electrically coupled to traces on the PCB. FIG. 3B illustrates example couplings of the ends of the windings 150, 160, 170, and 180 with respect to the circuit diagram shown in FIG. 2. Particularly, the first end 151 of the winding 150 can be coupled as the SW₁ input node of the current doubler rectifier 100. The first end 161 of the winding 160 can be coupled as the SW₂ input node of the current doubler rectifier 100. The second end 152 of the winding 150 and the second end 162 of the winding 160 can be electrically coupled together on a trace of the PCB as the Mid1 node in the current doubler rectifier 100. In some cases, the windings 150 and 160 can be formed as a single, continuous winding that extends continuously over the Mid1 node. In this case, it is not necessary to couple the second end 152 of the winding 150 and the second end 162 of the winding 160 together on the PCB.

Referring still to FIG. 3B, the first end 171 of the winding 170 and the first end 181 of the winding 180 can be electrically coupled together on another trace of the PCB as the Vₒ node in the current doubler rectifier 100. In some cases, the windings 170 and winding 180 can be formed to include a continuous integrated end (i.e., with a conductive bar across the first end 171 and the first end 181) over the Vₒ node. The second end 172 of the winding 170 can be electrically coupled to another trace of the PCB for coupling to the SR₁ synchronous rectifier. The second end 182 of the winding 180 can be electrically coupled to another trace of the PCB for coupling to the SR₂ synchronous rectifier.

As noted above, magnetization inductances in the integrated transformer 110 act as inductors for the current doubler rectifier 100. The arrangement of the integrated transformer 110, including the twisted central legs 124A and 124B of the first and second core components 120A and 120B, respectively, permit coupling of magnetic flux among the windings 150, 160, 170, and 180, resulting in the magnetization inductances denoted Lₘ₁ and Lₘ₂ in FIG. 2. The magnetization inductances Lₘ₁ and Lₘ₂ of the integrated transformer 110 operate as inductors in the current doubler rectifier 100, similar to the inductors L₁ and L₂ shown in FIGS. 1A and 1B. The use of the integrated transformer 110 can be preferable to using a transformer and separate inductors in the current doubler rectifier 100, as the integrated transformer 110 can reduce cost and increase power density as compared to the use of separate transformers and inductors. The twisted central legs 124A and 124B of the first and second core components 120A and 120B also permit the reduction of the number of turns used in the windings 150, 160, 170, and 180, as compared to other types of cores.

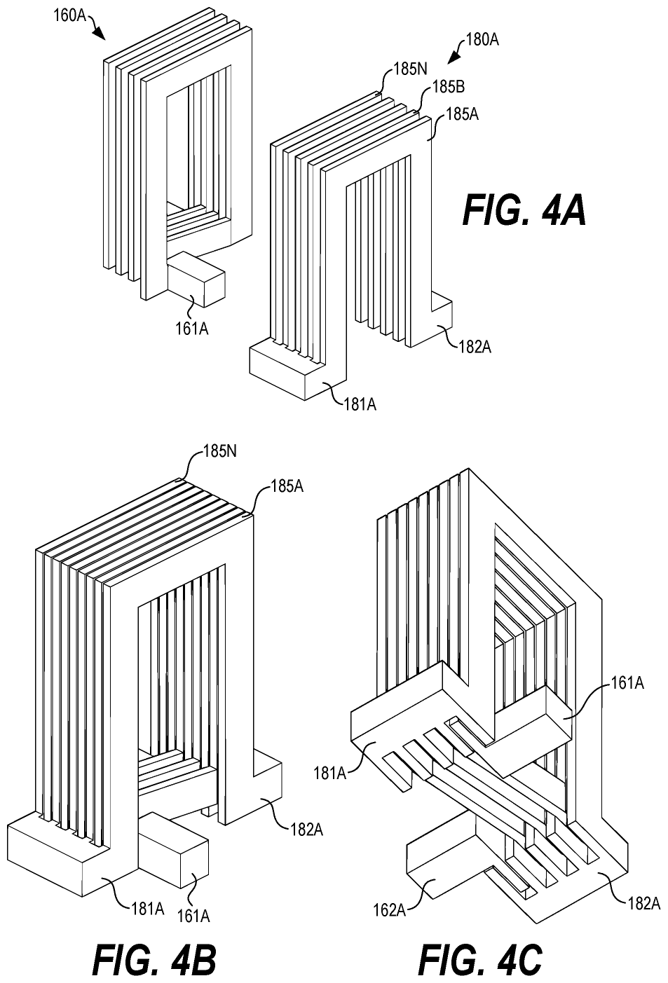

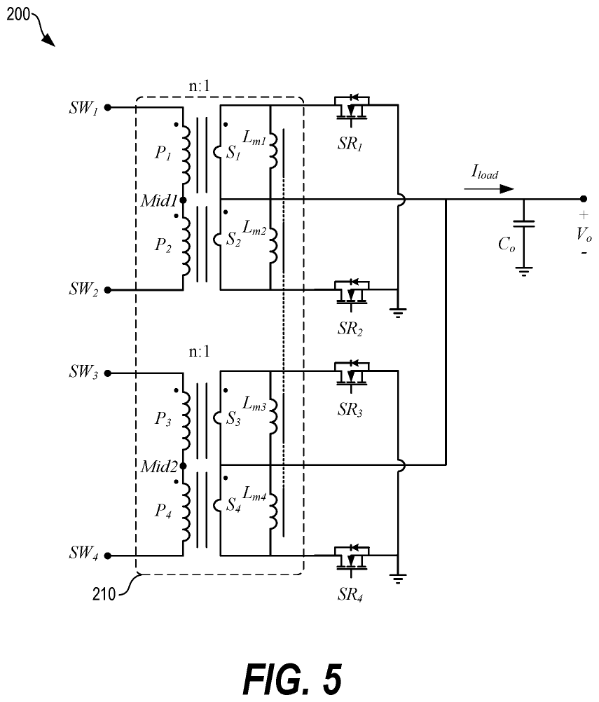

In other aspects of the embodiments, the windings in the integrated transformers described herein, such as in the integrated transformer 110, among others described herein, can be implemented in other ways. FIG. 4A illustrates a top perspective view of an example primary winding 160A and an example secondary winding 180A, which can be interleaved together, for use in the integrated transformers described herein. FIG. 4B illustrates a top perspective view of the primary and secondary windings 160A and 180A shown in FIG. 4A, interleaved together, and FIG. 4C illustrates a bottom perspective view of the primary and secondary windings 160A and 180A.

As compared to the secondary winding 180 described above and shown in FIGS. 3A-3C, the secondary winding 180A includes a number of winding fins 185A-185N (collectively “winding fins 185”). Each of the winding fins 185 extends between a first end 181A of the winding 180A and a second end 182A of the winding 180A. While the secondary winding 180A is illustrated to include five winding fins 185 in the example shown in FIGS. 4A-4C, the secondary winding 180A can include other numbers of winding fins 185 in other examples. The primary winding 160A in FIGS. 4A-4C is similar to the primary winding 160 shown in FIGS. 3A-3C, and it includes four turns. However, the primary winding 160A is larger than the primary winding 160, and the turns of the primary winding 160A can be interleaved among the winding fins 185 of the secondary winding 180A, as shown in FIGS. 4B and 4C. Thus, the secondary winding 180A does not wrap over the primary winding 160A, as the secondary winding 180 wraps over the primary winding 160, as best seen in a comparison of FIG. 3C with FIG. 4B.

Windings similar to the primary and secondary windings 160A and 180A can be used in place of the windings 150 and 170, respectively, in the integrated transformer 110. Windings similar to the primary and secondary windings 160A and 180A can also be used in place of the windings 160 and 180, respectively, in the integrated transformer 110. Windings similar to the primary and secondary windings 160A and 180A shown in FIGS. 4A-4C can also be used in place of other primary and secondary winding pairs among other integrated transformer structures described herein. The interleaving of the primary and secondary windings 160A and 180A can result in better coupling among the primary and secondary sides of the integrated transformer structures. The interleaved windings can reduce leakage inductance between the primary and secondary windings, which can also reduce electromagnetic interference (EMI) issues.

Turning to other embodiments, FIG. 5 illustrates another example current doubler rectifier 200 with an integrated transformer and coupled inductors according to various aspects of the present disclosure. The current doubler rectifier 200 includes multiple current doubler rectifier output stages or phases for applications demanding more power, and two stages are shown in FIG. 5. The current doubler rectifier 200 can also be extended to include any number of additional phases (e.g., “n” phases), depending on the power demand for the application. The current doubler rectifier 200 includes a single integrated transformer 210. The integrated transformer 210 is an integrated component among both of the current doubler rectifier stages or phases in the current doubler rectifier 200.

The first phase of the current doubler rectifier 200 includes the integrated transformer 210 and synchronous rectifiers SR₁ and SR₂. The second phase of the current doubler rectifier 200 includes the integrated transformer 210 and synchronous rectifiers SR₃ and SR₄. The current doubler rectifier 200 also includes an output capacitor Cₒ, among possibly other components. In some cases, the current doubler rectifier 200 can include other components that are not illustrated in FIG. 5, such as a controller, additional blocking, bulk, or other capacitors, additional inductors, rectifiers, or switching transistors, and other components. The current doubler rectifier 200 can be implemented using a combination of integrated and discrete circuit components, for example, on one or more PCBs.

The current doubler rectifier 200 can be relied upon as the output stage of a power converter. Thus, a half bridge inverter, a full bridge inverter, or related inverter circuit topology can be relied upon as an input to the current doubler rectifier 200 and electrically coupled between the SW₁ and SW₂ input nodes of the current doubler rectifier 200. A half bridge inverter, a full bridge inverter, or related inverter circuit topology can also be relied upon as an input to the current doubler rectifier 200 and electrically coupled between the SW₃ and SW₃ input nodes of the current doubler rectifier 200.

The current doubler rectifier 200 does not include separate transformers and inductors. The current doubler rectifier 14 shown in FIG. 1A, for example, includes a transformer 16 and two separate inductors L₁ and L₂. However, the current doubler rectifier 200 shown in FIG. 5 includes a single integrated transformer 210 in some examples. The integrated transformer 210 acts a transformer in the current doubler rectifier 200. Additionally, magnetization inductances in the integrated transformer 210 act as inductors for the current doubler rectifier 200. As shown in FIG. the integrated transformer 210 includes a first primary winding P₁, a second primary winding P₁, a third primary winding P₃, and a fourth primary winding P₄ (collectively “primary winding”). The integrated transformer 210 also includes a first secondary winding S₁, and a second secondary winding S₂, a third secondary winding S₃, and a fourth secondary winding S₄ (collectively “secondary winding”). The integrated transformer 210 also includes a magnetic core, which is described in further detail below. Magnetization inductances in the integrated transformer 210, denoted as Lₘ₁, Lₘ₂, Lₘ₃, and Lₘ₄ in FIG. 5, operate as the inductors in the current doubler rectifier 200, similar to the inductors L₁ and L₂ shown in FIGS. 1A and 1B.

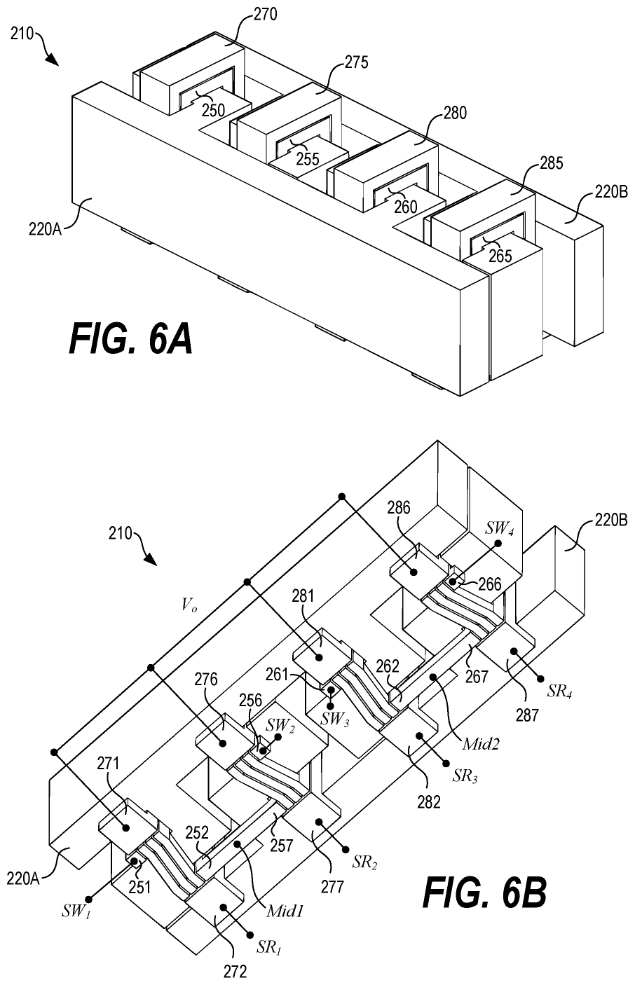

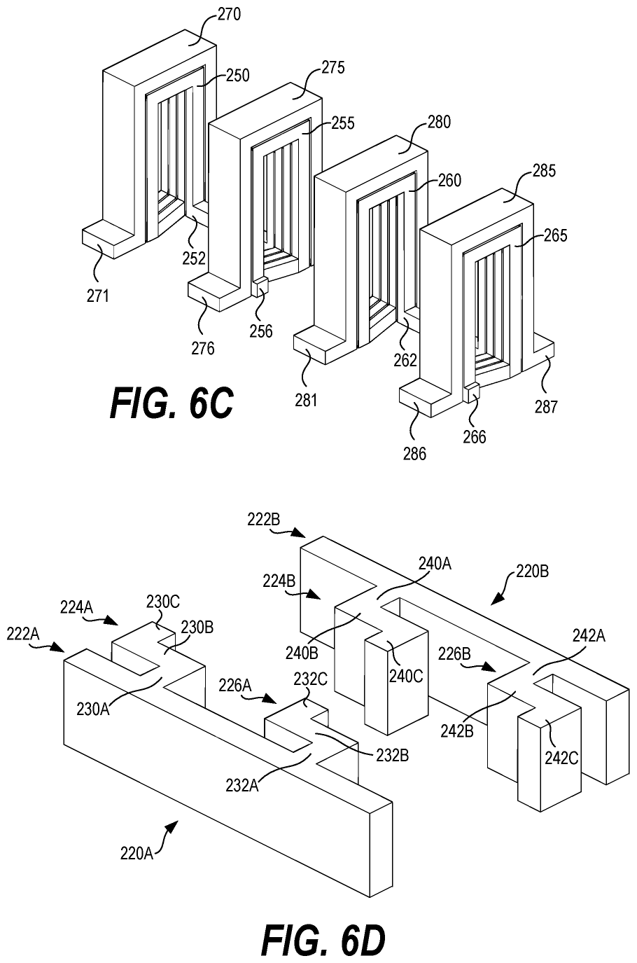

The structure of the integrated transformer 210 is different from other types of integrated magnetic structures used in current doubler rectifiers. FIG. 6A illustrates a top perspective view of the integrated transformer 210, and FIG. 6B illustrates a bottom perspective view of the integrated transformer 210. FIG. 6C illustrates the primary and secondary windings of the integrated transformer 210, with the core omitted, and FIG. 6D illustrates the core of the integrated transformer 210, with the windings omitted. Referring among FIGS. 6A-6D, the integrated transformer 210 includes a core having a first core component 220A and a second core component 220B (collectively “core 220”), a first primary winding 250, a second primary winding 255, a third primary winding 260, a fourth primary winding 265, a first secondary winding 270, a second secondary winding 275, a third secondary winding 280, and a fourth secondary winding 285.

The first primary winding 250 in FIGS. 6A-6D corresponds to the first primary winding P₁ shown in FIG. 5. The second primary winding 255 corresponds to the second primary winding P₂ shown in FIG. 5. The third primary winding 260 corresponds to the third primary winding P₃ shown in FIG. 5. The fourth primary winding 265 corresponds to the fourth primary winding P₄ shown in FIG. 5. The first secondary winding 270 in FIGS. 6A-6D corresponds to the first secondary winding S₁ shown in FIG. 5. The second secondary winding 275 corresponds to the second secondary winding S₂ shown in FIG. 5. The third secondary winding 280 corresponds to the third secondary winding S₃ shown in FIG. 5. The fourth secondary winding 285 corresponds to the fourth secondary winding S₄ shown in FIG. 5. In FIGS. 6A-6D, the primary windings 250, 255, 260, and 265 each include four turns, and the secondary windings 270, 275, 280, and 285 each include a single turn. In other examples, the primary windings 250, 255, 260, and 265 can include other numbers of turns. Additionally, the secondary windings 270, 275, 280, and 285 can include other numbers of turns.

The windings 250, 255, 260, 265, 270, 275, 280, and 285 of the integrated transformer 210 can be embodied as conductive windings formed from a conductive material, such as copper, for example. In one example, the windings 250, 255, 260, 265, 270, 275, 280, and 285 can be embodied as copper bar windings, although magnet wire, Litz wire, and other types of conductive wires can be relied upon for the windings 250, 255, 260, 265, 270, 275, 280, and 285. In some cases, the use of Litz wire can be preferred for reduced AC loss, reduced internal resistance, or other factors. If the windings 250, 255, 260, 265, 270, 275, 280, and 285 are implemented as wires (e.g., rather than copper bar windings) the windings 250, 255, 260, 265, 270, 275, 280, and 285 can be wound around bobbins and inserted into the core 220 of the integrated transformer 210.

The core 220 of the integrated transformer 210 can be embodied as a material of high magnetic permeability, such as a ferromagnetic material like iron, laminated silicon steel, laminated iron sheets, or other solid or laminated ferromagnetic ceramic, metal, metal alloy, or related material(s). As best shown in FIG. 6D, the core 220 is different than the typical “I,” “C,” “U,” “E,” and planar “E,” “I,” and related cores. Notably, both the first core component 220A and a second core component 220B include twisted or turned central legs.

As shown in FIG. 6D, the first core component 220A includes a back segment 222A, a first twisted central leg 224A, and a second twisted central leg 226A. The first twisted central leg 224A includes a first central segment 230A that extends perpendicular to the back segment 222A, a second central segment 230B that extends parallel to the back segment 222A, and a third central segment 230C that extends perpendicular to the back segment 222A. The first central segment 230A and the third central segment 230C extend parallel to each other and are connected by the second central segment 230B. The second twisted central leg 226A includes a first central segment 232A that extends perpendicular to the back segment 222A, a second central segment 232B that extends parallel to the back segment 222A, and a third central segment 232C that extends perpendicular to the back segment 222A. The first central segment 232A and the third central segment 232C extend parallel to each other and are connected by the second central segment 232B.

The second core component 220B includes a back segment 222B, a first twisted central leg 224B, and a second and twisted central leg 226B. The first twisted central leg 224B includes a first central segment 240A that extends perpendicular to the back segment 222B, a second central segment 240B that extends parallel to the back segment 222B, and a third central segment 240C that extends perpendicular to the back segment 222B. The first central segment 240A and the third central segment 240C extend parallel to each other and are connected by the second central segment 240B. The second twisted central leg 226B includes a first central segment 242A that extends perpendicular to the back segment 222B, a second central segment 242B that extends parallel to the back segment 222B, and a third central segment 242C that extends perpendicular to the back segment 222B. The first central segment 242A and the third central segment 242C extend parallel to each other and are connected by the second central segment 242B. The first core component 220A and a second core component 220B are positioned in the integrated transformer 110 such that no or substantially no air gap exists between them in the integrated transformer 210.

In the integrated transformer 210, the windings 250 and 270 extend around the second central segment 230B of the first core component 220A, the windings 255 and 275 extend around the second central segment 240B of the second core component 220B, the windings 260 and 280 extend around the second central segment 232B of the first core component 220A, and the windings 265 and 285 extend around the second central segment 242B of the second core component 220B.

The integrated transformer 210 can be mounted to a PCB, in one example, and the ends of the windings 250, 255, 260, 265, 270, 275, 280, and 285 can be electrically coupled to traces on the PCB. FIG. 6B illustrates example couplings of the ends of the windings 250, 255, 260, 265, 270, 275, 280, and 285 with respect to the circuit diagram shown in FIG. 5. Particularly, the first end 251 of the winding 250 can be coupled as the SW₁ input node of the current doubler rectifier 200. The first end 256 of the winding 255 can be coupled as the SW₂ input node of the current doubler rectifier 200. The first end 261 of the winding 260 can be coupled as the SW₃ input node of the current doubler rectifier 200. The first end 266 of the winding 265 can be coupled as the SW₄ input node of the current doubler rectifier 200.

The second end 252 of the winding 250 and the second end 257 of the winding 255 are electrically coupled together at the Mid1 node in the current doubler rectifier 200. In some cases, as shown in FIG. 6B, the windings 250 and 255 can be formed as a single, continuous winding that extends continuously over the Mid1 node. In other cases, the second end 252 of the winding 250 and the second end 257 of the winding 255 can be coupled together on the PCB. The second end 262 of the winding 260 and the second end 267 of the winding 265 are electrically coupled together at the Mid2 node in the current doubler rectifier 200. In some cases, as shown in FIG. 6B, the windings 260 and 265 can be formed as a single, continuous winding that extends continuously over the Mid2 node. In other cases, the second end 262 of the winding 260 and the second end 267 of the winding 265 can be coupled together on the PCB.

Referring still to FIG. 6B, the first end 271 of the winding 270, the first end 276 of the winding 275, the first end 281 of the winding 280, and the first end 286 of the winding 285 can be electrically coupled together on another trace of the PCB as the Vₒ node in the current doubler rectifier 200. In some cases, the windings 270, 275, 280, and 285 can be formed to include a continuous integrated end (i.e., with a conductive bar across the ends 271, 276, 281, and 286) over the Vₒ node. The second end 272 of the winding 270 can be electrically coupled to another trace of the PCB for coupling to the SR₁ synchronous rectifier. The second end 277 of the winding 275 can be electrically coupled to another trace of the PCB for coupling to the SR₂ synchronous rectifier. The second end 282 of the winding 280 can be electrically coupled to another trace of the PCB for coupling to the SR₃ synchronous rectifier. The second end 287 of the winding 285 can be electrically coupled to another trace of the PCB for coupling to the SR₄ synchronous rectifier.

As noted above, magnetization inductances in the integrated transformer 210 act as inductors for the current doubler rectifier 200. The twisted central legs 224A, 226A, 224B, and 226B of the first and second core components 220A and 220B permit coupling of magnetic flux among the windings 250, 255, 260, 265, 270, 275, 280, and 285, resulting in the magnetization inductances denoted Lₘ₁, Lₘ₂, Lₘ₃, and Lₘ₄ in FIG. 5. The magnetization inductances Lₘ₁, Lₘ₂, Lₘ₃, and Lₘ₄ of the integrated transformer 210 operate as inductors in the current doubler rectifier 200, similar to the inductors L₁ and L₂ shown in FIGS. 1A and 1B. The use of the integrated transformer 210 can be preferable to using a transformer and separate inductors in the current doubler rectifier 200, as the integrated transformer 210 can reduce cost and increase power density as compared to the use of separate transformers and inductors. The twisted central legs 224A, 226A, 224B, and 226B of the first and second core components 220A and 220B also permit the reduction of the number of turns used in the windings 250, 255, 260, 265, 270, 275, 280, and 285, as compared to other types of cores. It is also noted that the windings 250, 255, 260, 265, 270, 275, 280, and 285 shown in FIGS. 6A-6D can, alternatively, be implemented using the interleaved windings described with reference to FIGS. 4A-4C.

Because the core components in the integrated transformers described above have twisted central legs, the transformers may be more costly to manufacture. Additionally, there can be a trade-off between the windings and the magnetic cores with magnetic coupling. Further, larger integrated transformers (e.g., such as that shown in FIGS. 6A-6D), which are needed in multiphase current doubler rectifiers for higher power level applications, can exhibit asymmetric magnetic coupling over the integrated transformer. For example, the magnetic flux associated with windings on one side of the transformer may not be uniformly distributed across the whole transformer for magnetic coupling. The asymmetric magnetic coupling can lead to different and varying inductances among the phases, output voltage ripple, and other issues in power converters. The asymmetry in magnetic coupling becomes even more significant with increased phases.

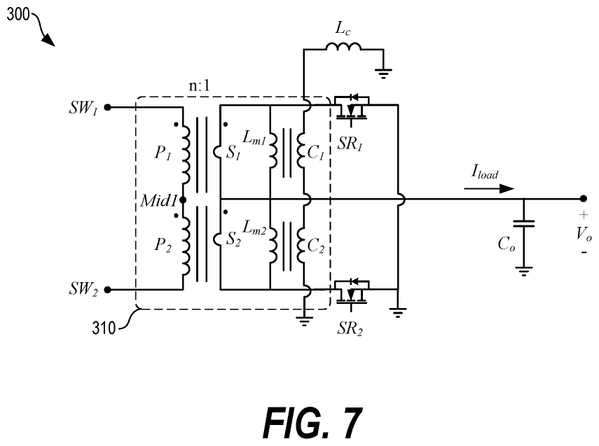

In view of the concerns described above, the embodiments also include multiphase current doubler rectifiers with integrated transformers that include coupling windings. FIG. 7 illustrates an example current doubler rectifier 300 according to various aspects of the present disclosure. The current doubler rectifier 300 includes an integrated transformer 310, synchronous rectifiers SR₁ and SR₂, an output capacitor Cₒ, and a coupling inductor L_{c}, among possibly other components. In some cases, the current doubler rectifier 300 can include other components that are not illustrated in FIG. 7, such as a controller, additional blocking, bulk, or other capacitors, additional inductors, rectifiers, or switching transistors, and other components. The current doubler rectifier 300 can be implemented using a combination of integrated and discrete circuit components, for example, on one or more PCBs.

The current doubler rectifier 300 can be relied upon as the output stage of a power converter. As examples, the current doubler rectifier 300 can be relied upon as the output stage of the power converters 10 and 20 shown in FIGS. 1A and 1B. Thus, a half bridge inverter, a full bridge inverter, or related inverter circuit topology can be relied upon as an input to the current doubler rectifier 300 and electrically coupled between the SW₁ and SW₂ input nodes of the current doubler rectifier 300.

The current doubler rectifier 300 does not include a transformer and inductors that are separate from the transformer. The current doubler rectifier 14 shown in FIG. 1A, for example, includes a transformer 16 and two separate inductors L₁ and L₂. However, the current doubler rectifier 300 shown in FIG. 7 includes a single integrated transformer 310. The integrated transformer 310 acts a transformer in the current doubler rectifier 100. Additionally, magnetization inductances in the integrated transformer 310 act as inductors for the current doubler rectifier 300. As shown in FIG. 7, the integrated transformer 310 includes a first primary winding P₁, a second primary winding P₁, a first secondary winding S₁, a second secondary winding S₂, a first coupling winding C₁, and a second coupling winding C₂. The integrated transformer 310 also includes two magnetic cores, which are separated from each other and described in further detail below. Magnetic coupling between the two magnetic cores of the integrated transformer 310 is achieved by the first coupling winding C₁ and a second coupling winding C₂, as also described below. Magnetization inductances in the integrated transformer 310, denoted as Lₘ₁ and Lₘ₂ in FIG. 7, operate as the inductors in the current doubler rectifier 300, similar to the inductors L₁ and L₂ shown in FIGS. 1A and 1B.

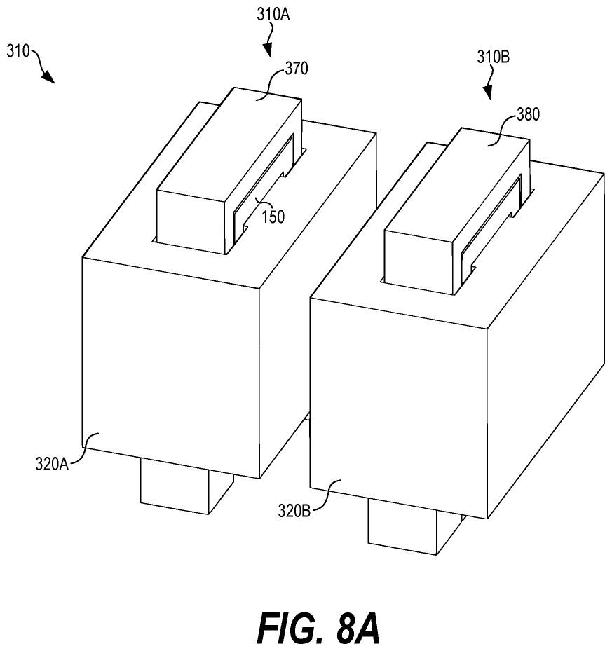

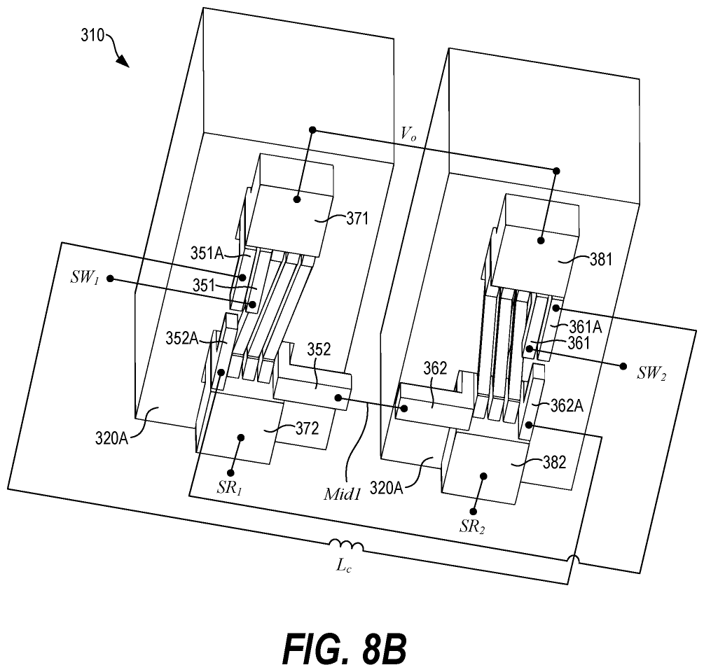

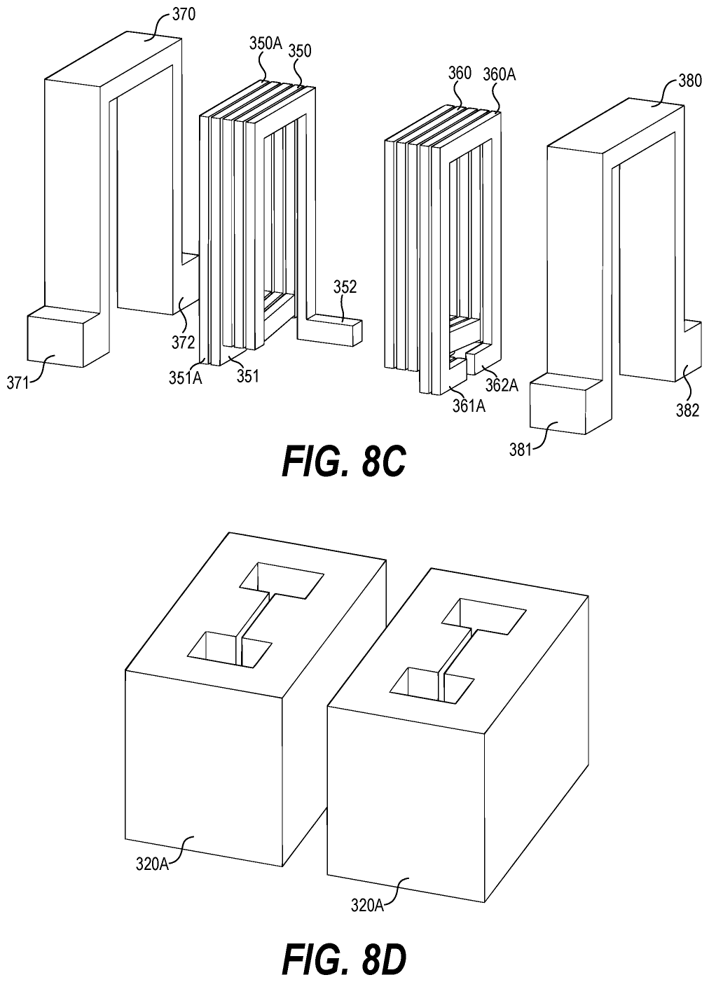

The structure of the integrated transformer 310 is different from other types of integrated magnetic structures used in current doubler rectifiers. The integrated transformer 310 is formed in two parts with two separate cores, and a coupling winding is used to distribute magnetic flux between the cores. FIG. 8A illustrates a top perspective view of the integrated transformer 310, FIG. 8B illustrates a bottom perspective view of the integrated transformer 310, FIG. 8C illustrates the windings of the integrated transformer 310, with the cores omitted, and FIG. 8D illustrates the cores of the integrated transformer 310, with the windings omitted. Referring among FIGS. 8A-8D, the integrated transformer 310 includes a first core 320A and a second core 320B (collectively “cores 320”), a first primary winding 350 and a second primary winding 360 (collectively “primary winding”), a first secondary winding 370 and a second secondary winding 380 (collectively “secondary winding”), and a first coupling winding 350A and and a second coupling winding 360A (collectively “coupling winding”).

As the first core 320A and the second core 320B are separated from each other, the integrated transformer 310 is formed as two transformer assemblies, including the first transformer assembly 310A and the second transformer assembly 310B. The first transformer assembly 310A and the second transformer assembly 310B are electrically coupled together, as described below and shown in FIG. 8B. The first primary winding 350 in FIGS. 8A-8D corresponds to the first primary winding P₁ shown in FIG. 7. The second primary winding 360 in FIGS. 8A-8D corresponds to the second primary winding P₂ shown in FIG. 7. The first secondary winding 370 in FIGS. 8A-8D corresponds to the first secondary winding S₁ shown in FIG. 7. The second secondary winding 380 in FIGS. 8A-8D corresponds to the second secondary winding S₂ shown in FIG. 7. The first coupling winding 350A in FIGS. 8A-8D corresponds to the first coupling winding C₁ shown in FIG. 7. The second coupling winding 360A in FIGS. 8A-8D corresponds to the second coupling winding C₂ shown in FIG. 7.

In the example shown, the first primary winding 350 and the second primary winding 360 each include four turns. The first secondary winding 370, the second secondary winding 380, first coupling winding 350A, and the second coupling winding 360A each include a single turn. In other examples, the first primary winding 350 and the second primary winding 360 can include other numbers of turns. Additionally, first secondary winding 370, the second secondary winding 380, first coupling winding 350A, and the second coupling winding 360A can include other numbers of turns.

The windings 350, 350A, 360, 360A, 370, and 380 of the integrated transformer 310 can be embodied as conductive windings formed from a conductive material, such as copper, for example. In one example, the windings 350, 350A, 360, 360A, 370, and 380 can be embodied as copper bar windings, although magnet wire, Litz wire, and other types of conductive wires can be relied upon for the windings 350, 350A, 360, 360A, 370, and 380. In some cases, the use of Litz wire can be preferred for reduced AC loss, reduced internal resistance, or other factors. If the windings 350, 350A, 360, 360A, 370, and 380 are implemented as wires (e.g., rather than copper bar windings) the windings 350, 350A, 360, 360A, 370, and 380 can be wound around bobbins and inserted into the cores 320 of the integrated transformer 310.

The cores 320 of the integrated transformer 310 can be embodied as a material of high magnetic permeability, such as a ferromagnetic material like iron, laminated silicon steel, laminated iron sheets, or other solid or laminated ferromagnetic ceramic, metal, metal alloy, or related material(s). As best shown in FIG. 8D, the cores 320A and 320B are embodied as shell type cores, although the cores 320A and 320B can also be embodied as “E” and “I” or other types of cores in other cases. In the integrated transformer 310, the windings 350, 350A, and 370 extend around the central segment of the core 320A, and the windings 360, 360A, and 380 extend around the central segment of the core 320B.

The integrated transformer 310 can be mounted to a PCB, in one example, and the ends of the windings 350, 350A, 360, 360A, 370, and 380 can be electrically coupled to traces on the PCB. FIG. 8B illustrates example couplings of the ends of the windings 350, 350A, 360, 360A, 370, and 380 with respect to the circuit diagram shown in FIG. 7. Particularly, the first end 351 of the winding 350 can be coupled as the SW₁ input node of the current doubler rectifier 300. The first end 361 of the winding 360 can be coupled as the SW₂ input node of the current doubler rectifier 300. The second end 352 of the winding 350 and the second end 362 of the winding 360 can be electrically coupled together on a trace of the PCB as the Mid1 node in the current doubler rectifier 100. In some cases, the windings 350 and 360 can be formed as a single, continuous winding that extends continuously over the Mid1 node. In this case, it is not necessary to couple the second end 352 of the winding 350 and the second end 362 of the winding 360 together on the PCB.

Referring still to FIG. 8B, the first end 371 of the winding 370 and the first end 381 of the winding 380 can be electrically coupled together on another trace of the PCB as the Vₒ node in the current doubler rectifier 300. In some cases, the windings 370 and winding 380 can be formed to include a continuous integrated end (i.e., with a conductive bar across the first end 371 and the first end 381) over the Vₒ node. The second end 372 of the winding 370 can be electrically coupled to another trace of the PCB for coupling to the SR₁ synchronous rectifier. The second end 382 of the winding 380 can be electrically coupled to another trace of the PCB for coupling to the SR₂ synchronous rectifier. The first coupling winding 350A and the second coupling winding 360A are electrically coupled together as shown in FIG. 8B with the coupling inductor L_{c}, which can be separately mounted on the PCB.

In the integrated transformer 310, because the structure of each half of the transformer is the same, the coupling coefficient between the transformer windings and the coupling windings is the same. This means that the coupling for the magnetizing inductors is symmetrical. The positions of the primary side windings and the coupling windings can be changed as compared to the example shown in FIGS. 8A-8D. The type and inductance of the coupling inductor L_{c} can be selected to adjust the equivalent coupling coefficient of the magnetizing inductors in the current doubler rectifier 300.

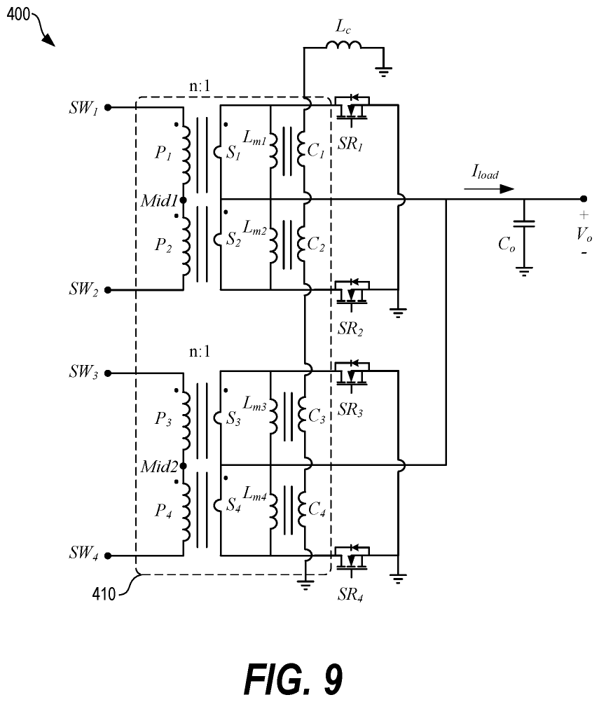

The current doubler rectifier 300 shown in FIG. 7 can be extended to include additional phases for higher power applications. FIG. 9 illustrates another example current doubler rectifier 400 with an integrated transformer 410 including a coupling winding according to various aspects of the present disclosure. The current doubler rectifier 400 includes multiple current doubler rectifier stages or phases for applications demanding more power, and two stages are shown in FIG. 9. The current doubler rectifier 400 can also be extended to include any number of additional phases (e.g., “n” phases), depending on the power demand for the application. The current doubler rectifier 400 includes a single integrated transformer 410. The integrated transformer 410 is an integrated component among both of the current doubler rectifier stages or phases in the current doubler rectifier 400.

The first phase of the current doubler rectifier 400 includes the integrated transformer 410 and synchronous rectifiers SR₁ and SR₂. The second phase of the current doubler rectifier 400 includes the integrated transformer 410 and synchronous rectifiers SR₃ and SR₄. The current doubler rectifier 400 also includes an output capacitor Cₒ, among possibly other components. In some cases, the current doubler rectifier 400 can include other components that are not illustrated in FIG. 9, such as a controller, additional blocking, bulk, or other capacitors, additional inductors, rectifiers, or switching transistors, and other components. The current doubler rectifier 400 can be implemented using a combination of integrated and discrete circuit components, for example, on one or more PCBs.

The current doubler rectifier 400 can be relied upon as the output stage of a power converter. Thus, a half bridge inverter, a full bridge inverter, or related inverter circuit topology can be relied upon as an input to the current doubler rectifier 400 and electrically coupled between the SW₁ and SW₂ input nodes of the current doubler rectifier 400. A half bridge inverter, a full bridge inverter, or related inverter circuit topology can also be relied upon as an input to the current doubler rectifier 400 and electrically coupled between the SW₃ and SW₃ input nodes of the current doubler rectifier 400.

The current doubler rectifier 400 does not include separate transformers and inductors. The current doubler rectifier 14 shown in FIG. 1A, for example, includes a transformer 16 and two separate inductors L₁ and L₂. However, the integrated transformer 410 acts a transformer in the current doubler rectifier 400, and magnetization inductances in the integrated transformer 410 act as inductors for the current doubler rectifier 400. As shown in FIG. 9, the integrated transformer 410 includes a first primary winding P₁, a second primary winding P₁, a third primary winding P₃, a fourth primary winding P₄. The integrated transformer 410 also includes a first secondary winding S₁, and a second secondary winding S₂, a third secondary winding S₃, and a fourth secondary winding S₄. The integrated transformer 410 also includes a first coupling winding C₁, a second coupling winding C₂, a third coupling winding C₁, and a fourth coupling winding C₄.

The integrated transformer 410 can be implemented in a number of ways described below. In one example, the integrated transformer 410 includes four magnetic cores. In other examples, however, it can include only two magnetic cores. Magnetic coupling between the magnetic cores of the integrated transformer 410 is achieved by the coupling windings C₁, C₂, C₃, and C₄, as also described below. Magnetization inductances in the integrated transformer 410, denoted as Lₘ₁, Lₘ₂, Lₘ₃, and Lₘ₄ in FIG. 9, operate as the inductors in the current doubler rectifier 400, similar to the inductors L₁ and L₂ shown in FIGS. 1A and 1B.

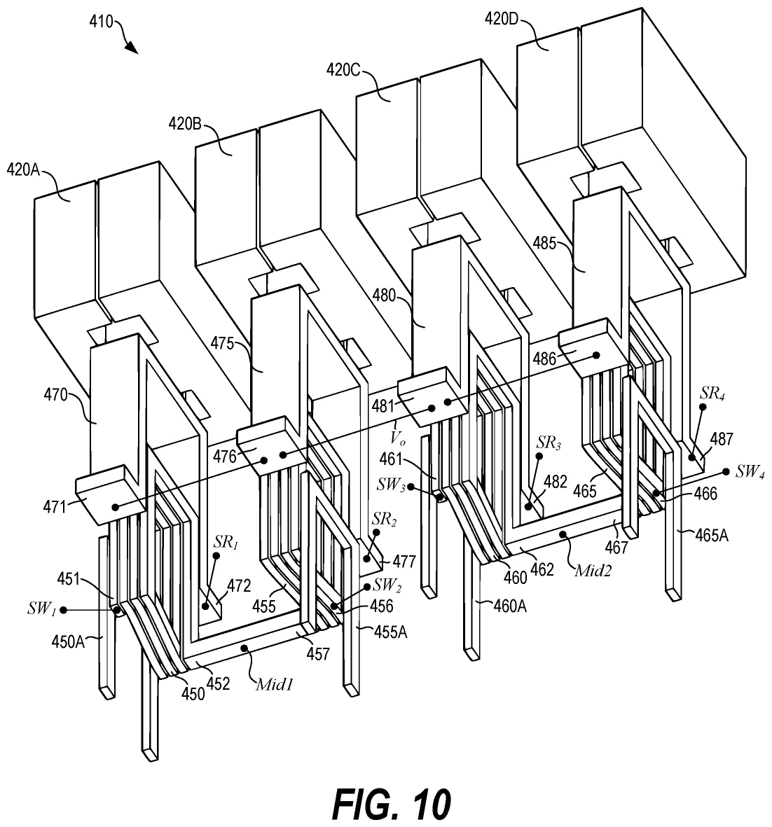

The structure of the integrated transformer 410 is different from other types of integrated magnetic structures used in current doubler rectifiers. In one example, the integrated transformer 410 is formed in four parts with four separate cores, and a coupling winding is used to distribute magnetic flux between the cores. FIG. 10 illustrates an exploded perspective view of an example integrated transformer 410 with a coupling winding according to various aspects of the present disclosure. The integrated transformer 410 includes a first core 420A, a second core 420B, a third core 420C, and a fourth core 420D (collectively “cores 420”). The integrated transformer 410 also includes a first primary winding 450, a second primary winding 455, a third primary winding 460, and a fourth primary winding 465. The integrated transformer 410 also includes a first secondary winding 470, a second secondary winding 475, a third secondary winding 480, and a fourth secondary winding 485. The integrated transformer 410 also includes a first coupling winding 450A, a second coupling winding 455A, a third coupling winding 460A, and a fourth coupling winding 465A.

The first primary winding 450 in FIG. 10 corresponds to the first primary winding P₁ shown in FIG. 9. The second primary winding 455 corresponds to the second primary winding P₂ shown in FIG. 9. The third primary winding 460 corresponds to the third primary winding P₃ shown in FIG. 9. The fourth primary winding 465 corresponds to the fourth primary winding P₄ shown in FIG. 9. The first secondary winding 470 in FIGS. 6A-6D corresponds to the first secondary winding S₁ shown in FIG. 9. The second secondary winding 475 corresponds to the second secondary winding S₂ shown in FIG. 9. The third secondary winding 480 corresponds to the third secondary winding S₃ shown in FIG. 9. The fourth secondary winding 485 corresponds to the fourth secondary winding S₄ shown in FIG. 9. The first coupling winding 450A in FIG. 10 corresponds to the first coupling winding C₁ shown in FIG. 9. The second coupling winding 455A corresponds to the second coupling winding C₂ shown in FIG. 9. The third coupling winding 460A corresponds to the third coupling winding C₃ shown in FIG. 9. The fourth coupling winding 465A corresponds to the fourth coupling winding C₄ shown in FIG. 9.

The windings of the integrated transformer 410 can be embodied as conductive windings formed from a conductive material, such as copper, for example. In one example, the windings can be embodied as copper bar windings, although magnet wire, Litz wire, and other types of conductive wires can be relied upon. In some cases, the use of Litz wire can be preferred for reduced AC loss, reduced internal resistance, or other factors. If the windings are implemented as wires (e.g., rather than copper bar windings) the windings can be wound around bobbins and inserted into the cores 420 of the integrated transformer 410.

The cores 420 of the integrated transformer 410 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, each of the cores 420 comprises an “EE” core. In other examples, “ER” or “EQ” cores can be relied upon. Each of the cores 420 includes side legs and a center leg, with air gaps in the side legs and no air gap in the center leg. The primary, secondary, and coupling windings extend around the center legs of the cores 420 in the example shown.

The integrated transformer 410 can be mounted to a PCB, in one example, and ends of certain windings can be electrically coupled to traces on the PCB. FIG. 10 illustrates example couplings of the ends of the windings with respect to the circuit diagram shown in FIG. 7. Particularly, the first end 451 of the winding 450 can be coupled as the SW₁ input node of the current doubler rectifier 400. The first end 456 of the winding 455 can be coupled as the SW₂ input node of the current doubler rectifier 400. The first end 461 of the winding 460 can be coupled as the SW₃ input node of the current doubler rectifier 400. The first end 466 of the winding 465 can be coupled as the SW₄ input node of the current doubler rectifier 400.

The second end 452 of the winding 450 and the second end 457 of the winding 455 are electrically coupled together at the Mid1 node in the current doubler rectifier 400. In some cases, as shown in FIG. 10, the windings 450 and 455 can be formed as a single, continuous winding that extends continuously over the Mid1 node. In other cases, the second end 452 of the winding 450 and the second end 457 of the winding 455 can be coupled together on the PCB. The second end 462 of the winding 460 and the second end 467 of the winding 465 are electrically coupled together at the Mid2 node in the current doubler rectifier 400. In some cases, as shown in FIG. 10, the windings 460 and 465 can be formed as a single, continuous winding that extends continuously over the Mid2 node. In other cases, the second end 462 of the winding 460 and the second end 467 of the winding 465 can be coupled together on the PCB.

Referring still to FIG. 10, the first end 471 of the winding 470, the first end 476 of the winding 475, the first end 481 of the winding 480, and the first end 486 of the winding 485 can be electrically coupled together on another trace of the PCB as the Vₒ node in the current doubler rectifier 400. In some cases, the windings 470, 475, 480, and 485 can be formed to include a continuous integrated end (i.e., with a conductive bar across the ends 471, 476, 481, and 486) over the Vₒ node. The second end 472 of the winding 470 can be electrically coupled to another trace of the PCB for coupling to the SR₁ synchronous rectifier. The second end 477 of the winding 475 can be electrically coupled to another trace of the PCB for coupling to the SR₂ synchronous rectifier. The second end 482 of the winding 480 can be electrically coupled to another trace of the PCB for coupling to the SR₃ synchronous rectifier. The second end 487 of the winding 485 can be electrically coupled to another trace of the PCB for coupling to the SR₄ synchronous rectifier. Additionally, the ends of the coupling windings 450A, 455A, 460A, and 465A are electrically coupled together with the coupling inductor L_{c}, which can be separately mounted on the PCB, according to the schematic shown in FIG. 9. That is, the coupling windings 450A, 455A, 460A, and 465A are electrically coupled together as shown in FIG. 9 with the coupling inductor L_{c}, which can be separately mounted on the PCB.

In the integrated transformer 410, because the structures of each part of the transformer are the same, the coupling coefficient between the transformer windings and the coupling windings is the same. This means that the coupling for the magnetizing inductors is symmetrical. The positions of the primary side windings and the coupling windings can be changed as compared to the example shown in FIG. 10. The type and inductance of the coupling inductor L_{c} can also be selected to adjust the equivalent coupling coefficient of the magnetizing inductors in the current doubler rectifier 400.

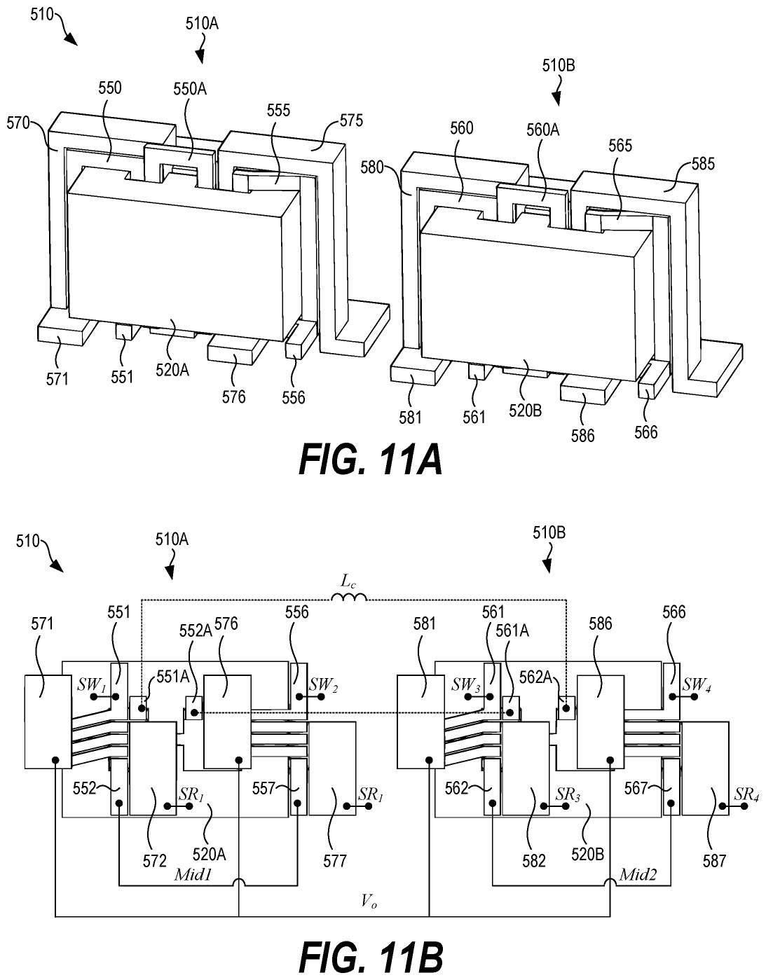

The integrated transformer 410 shown in FIG. 10 has symmetrical coupling but does not offer DC flux cancellation, as the DC flux paths are independent between the separated cores. Thus, for example, the DC flux of the integrated transformer 410 shown in FIG. 10 is larger than that in the integrated transformer 210 shown in FIGS. 6A-6D, because the integrated transformer 210 permits some DC flux cancellation. To keep the benefit of DC flux cancellation and symmetrical coupling, a hybrid integration method can be relied upon, as shown in FIGS. 11A and 11B.

FIG. 11A illustrates a perspective view of an example integrated transformer 510 with a coupling winding, and FIG. 11B illustrates a bottom view of the integrated transformer 510. The integrated transformer 510 can be used in place of the integrated transformer 410 in the current doubler rectifier 400 shown in FIG. 9, for example. The integrated transformer 510 includes a first core 520A and a second core 520B (collectively “cores 520”). The integrated transformer 510 also includes a first primary winding 550, a second primary winding 555, a third primary winding 560, and a fourth primary winding 565 (collectively “primary winding”). The integrated transformer 510 also includes a first secondary winding 570, a second secondary winding 575, a third secondary winding 580, and a fourth secondary winding 585 (collectively “secondary winding”). The integrated transformer 510 also includes a first coupling winding 550A and a second coupling winding 560A (collectively “coupling winding”).

As the first core 520A and the second core 520B are separated from each other, the integrated transformer 510 is formed as two transformer assemblies, including the first transformer assembly 510A and the second transformer assembly 510B. The first transformer assembly 510A and the second transformer assembly 510B can be electrically coupled together as shown in FIG. 11B. The first primary winding 550 in FIGS. 11A and 11B corresponds to the first primary winding P₁ shown in FIG. 9. The second primary winding 555 corresponds to the second primary winding P₂ shown in FIG. 9. The third primary winding 560 corresponds to the third primary winding P₃ shown in FIG. 9. The fourth primary winding 565 corresponds to the fourth primary winding P₄ shown in FIG. 9. The first secondary winding 570 in FIGS. 11A and 11B corresponds to the first secondary winding S₁ shown in FIG. 9. The second secondary winding 575 corresponds to the second secondary winding S₂ shown in FIG. 9. The third secondary winding 580 corresponds to the third secondary winding S₃ shown in FIG. 9. The fourth secondary winding 585 corresponds to the fourth secondary winding S₄ shown in FIG. 9. The first coupling winding 550A in FIGS. 11A and 11B corresponds to a combination of the coupling windings C₁ and C₂ shown in FIG. 9. The second coupling winding 560A corresponds to a combination of the coupling windings C₃ and C₄ shown in FIG. 9.

The windings of the integrated transformer 510 can be embodied as conductive windings formed from a conductive material, such as copper, for example. In one example, the windings can be embodied as copper bar windings, although magnet wire, Litz wire, and other types of conductive wires can be relied upon. In some cases, the use of Litz wire can be preferred for reduced AC loss, reduced internal resistance, or other factors. If the windings are implemented as wires (e.g., rather than copper bar windings) the windings can be wound around bobbins and inserted into the cores 520 of the integrated transformer 510.

The cores 520 of the integrated transformer 510 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, each of the cores 520 comprises an “EE” core. In other examples, “ER” or “EQ” cores can be relied upon. Each of the cores 520 includes side legs and a center leg, with air gaps in the center leg and no air gaps in the side legs. The primary and secondary windings extend around the side legs of the cores 520 in the example shown. The coupling windings extend around the center legs of the cores 520 in the example shown. The center legs of the cores 520 form an auxiliary pathway for magnetic flux, and the center legs of the cores 520 can also be referred to herein as auxiliary legs. As compared to the integrated transformer 410 shown in FIG. 10, in which four separate cores 420 are used, the integrated transformer 510 achieves DC flux cancellation in the core 520A and DC flux cancellation in the core 520B, and less cores are used overall.

The integrated transformer 510 can be mounted to a PCB, in one example, and ends of certain windings can be electrically coupled to traces on the PCB. For example, the first end 551 of the winding 550 can be coupled as the SW₁ input node of the current doubler rectifier 400 shown in FIG. 1. The first end 556 of the winding 555 can be coupled as the SW₂ input node of the current doubler rectifier 400. The first end 561 of the winding 560 can be coupled as the SW₃ input node of the current doubler rectifier 400. The first end 566 of the winding 565 can be coupled as the SW₄ input node of the current doubler rectifier 400.

The second end 552 of the winding 550 and the second end 557 of the winding 555 are electrically coupled together at the Mid1 node in the current doubler rectifier 400. In some cases, the windings 550 and 555 can be formed as a single, continuous winding that extends continuously over the Mid1 node. In other cases, the second end 552 of the winding 550 and the second end 557 of the winding 555 can be coupled together on the PCB. The second end 562 of the winding 560 and the second end 567 of the winding 565 are electrically coupled together at the Mid2 node in the current doubler rectifier 400. In some cases, the windings 560 and 565 can be formed as a single, continuous winding that extends continuously over the Mid2 node. In other cases, the second end 562 of the winding 560 and the second end 567 of the winding 565 can be coupled together on the PCB.

The first end 571 of the winding 570, the first end 576 of the winding 575, the first end 581 of the winding 580, and the first end 586 of the winding 585 can be electrically coupled together on another trace of the PCB as the Vₒ node in the current doubler rectifier 400. In some cases, the windings 570, 575, 580, and 585 can be formed to include a continuous integrated end (i.e., with a conductive bar across the ends 571, 576, 581, and 586) over the Vₒ node. The second end 572 of the winding 570 can be electrically coupled to another trace of the PCB for coupling to the SR₁ synchronous rectifier. The second end 577 of the winding 575 can be electrically coupled to another trace of the PCB for coupling to the SR₂ synchronous rectifier. The second end 582 of the winding 580 can be electrically coupled to another trace of the PCB for coupling to the SR₃ synchronous rectifier. The second end 587 of the winding 585 can be electrically coupled to another trace of the PCB for coupling to the SR₄ synchronous rectifier. Additionally, the ends of the coupling windings 550A and 560A are electrically coupled together with the coupling inductor L_{c}, which can be separately mounted on the PCB, consistent with the schematic shown in FIG. 9. That is, the ends 551A and 552A of the coupling winding 550A and the ends 561A and 561A of the coupling winding 560A are electrically coupled together as shown in FIG. 11B with the coupling inductor L_{c}, which can be separately mounted on the PCB.

In the integrated transformer 510, because the structures of each part of the transformer are the same, the coupling coefficient between the transformer windings and the coupling windings is the same. This means that the coupling for the magnetizing inductors is symmetrical. The type and inductance of the coupling inductor L_{c} can also be selected to adjust the equivalent coupling coefficient of the magnetizing inductors in the current doubler rectifier 400.

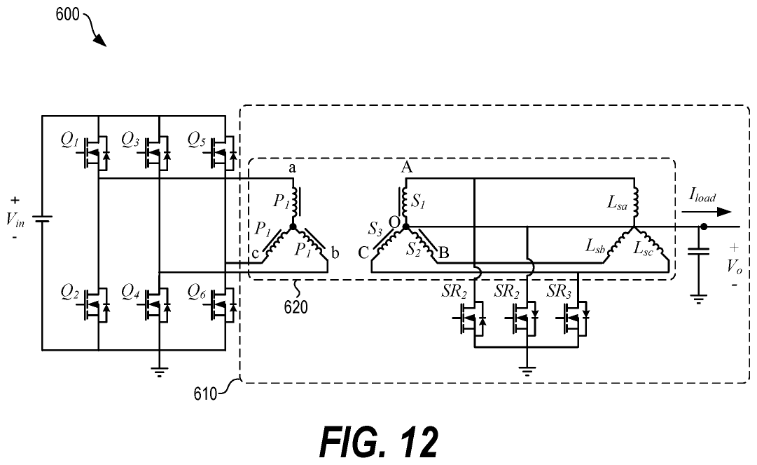

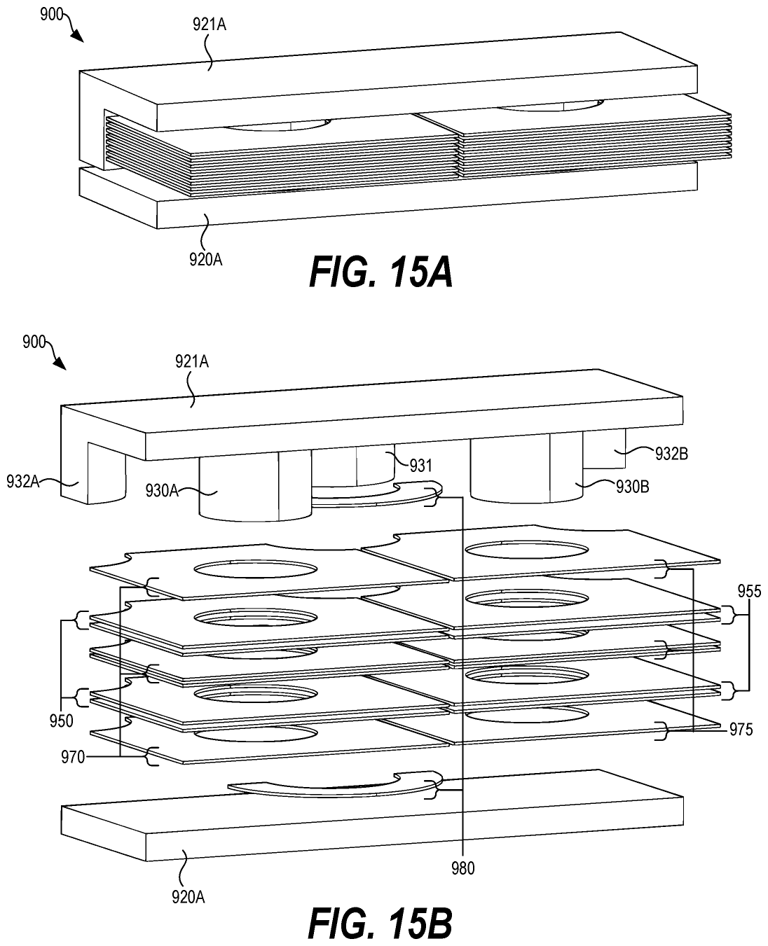

The integrated transformer concepts described above can also be extended to other types of multiphase interleaving in isolated DC/DC converters. As one example, FIG. 15 illustrates an example power converter 600 with a current trippler rectifier 610 according to various aspects of the present disclosure. The current trippler rectifier 610 includes an integrated transformer 620, synchronous rectifiers SR₁SR₂, and SR₃, an output capacitor Cₒ, and possibly other components. The integrated transformer 620 acts a transformer in the current trippler rectifier 610. Additionally, magnetization inductances in the integrated transformer 620 act as inductors for the current trippler rectifier 610. The integrated transformer 620 includes a first primary winding P₁, a second primary winding P₁, a third primary winding P₃, a first secondary winding S₁, a second secondary winding S₂, and a third secondary winding S₃. The integrated transformer 620 also includes a magnetic core. Magnetization inductances in the integrated transformer 620, denoted as Lₛₐ, L_{sb}, and L_{sc} in FIG. 12, operate as inductors in current trippler rectifier 610, similar to the inductors L₁ and L₂ shown in FIGS. 1A and 1B.

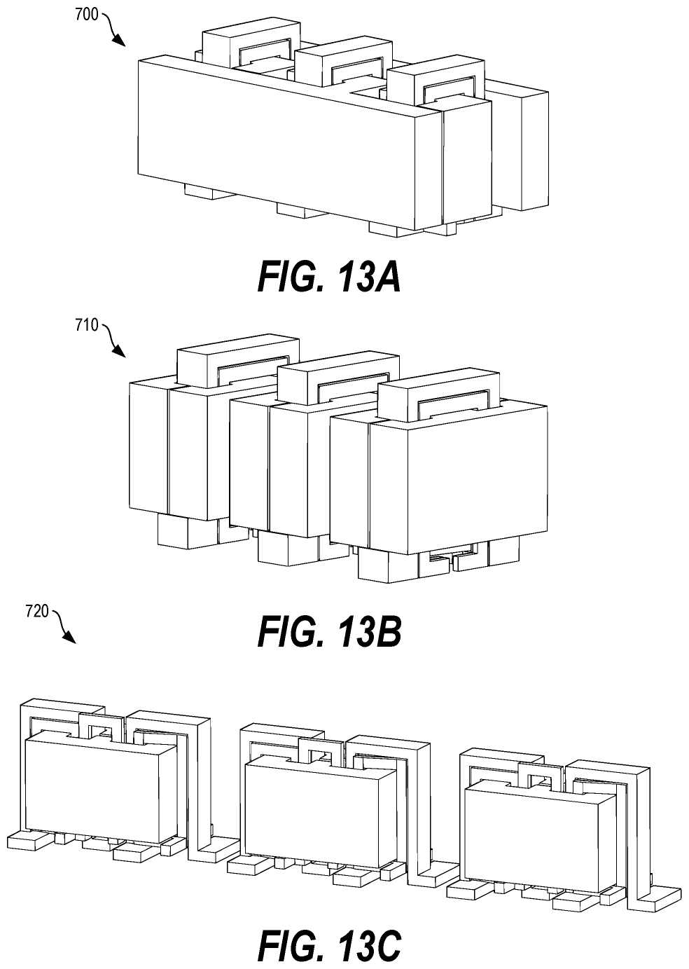

The integrated transformer 620 can be realized by extension of the integrated transformers shown in FIG. 3A-3D, 6A-6D, 8A-8D, 10, or 11A-11B. For example, FIG. 13A illustrates an integrated transformer 700. The integrated transformer 700 is an extension of the integrated transformer shown in FIG. 3A-3D or 6A-6D, and includes cores having twisted central legs, for use with the current trippler rectifier 610. The integrated transformer 700 is an example implementation of the integrated transformer 620 shown in FIG. 12. FIG. 13B illustrates another integrated transformer 710. The integrated transformer 710 is an extension of the integrated transformer shown in FIG. 8A-8D or 10, for use with the current trippler rectifier 610. The integrated transformer 710 is an example implementation of the integrated transformer 620 shown in FIG. 12. FIG. 13C illustrates another integrated transformer 720. The integrated transformer 720 is an extension of the integrated transformer shown in FIGS. 11A-11B, for use with the current trippler rectifier 610. The integrated transformer 720 is an example implementation of the integrated transformer 620 shown in FIG. 12.

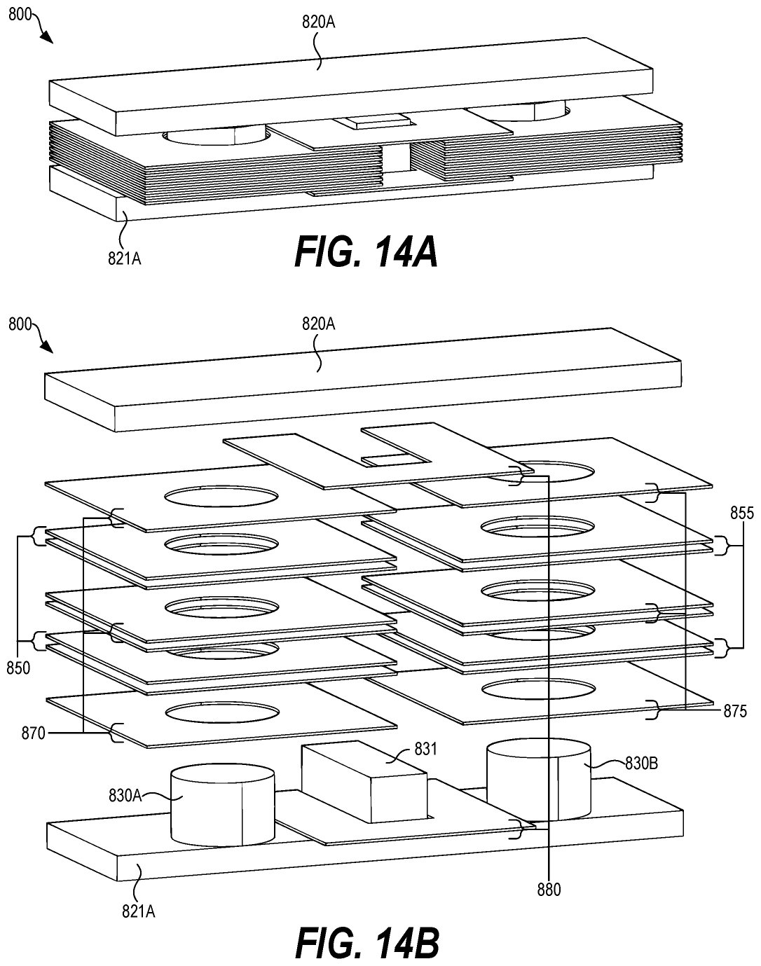

The integrated transformers described herein can also be embodied in other form factors. For example, planar-style cores can be relied upon, and the windings of the transformers can be implemented as planar windings. The planar windings can be implemented as layers on PCBs in some cases. FIG. 14A illustrates an example of a planar integrated transformer 800 with a coupling winding according to various aspects of the present disclosure, and FIG. 14B illustrates an exploded view of the planar integrated transformer 800 shown in FIG. 14A. As one example, the integrated transformer 800 can be used in place of the integrated transformer 310 in the current doubler rectifier 300 shown in FIG. 7. As another example, the integrated transformer 800 can be used in place of the integrated transformer 510A or 510B in the current doubler rectifier 400 shown in FIG. 9. Additionally, two integrated transformers similar to the integrated transformer 800 can be used together, in place of each of the integrated transformers 510A and 510B.

Referring between FIGS. 14A and 14B, the integrated transformer 800 includes a core, including a first core component 820A and a second core component 821A (collectively “core 800”). The integrated transformer 800 also includes a first primary winding 850 and a second primary winding 855 (collectively “primary winding”). The integrated transformer 800 also includes a first secondary winding 870 and a second secondary winding 875 (collectively “secondary winding”). The integrated transformer 800 also includes a coupling winding 880.

If implemented with the current doubler rectifier 300 shown in FIG. 7, as one example, the first primary winding 850 in FIGS. 14A and 14B corresponds to the first primary winding P₁ shown in FIG. 7. The second primary winding 855 corresponds to the second primary winding P₂ shown in FIG. 7. The first secondary winding 870 in FIGS. 14A and 14B corresponds to the first secondary winding S₁ shown in FIG. 7. The second secondary winding 975 corresponds to the second secondary winding S₂ shown in FIG. 7. The coupling winding 880 in FIGS. 14A and 14B corresponds to a combination of the coupling windings C₁ and C₂ shown in FIG. 7.

The windings of the integrated transformer 800 can be embodied as conductive layers of metal (e.g., copper layers) in a PCB, separated by laminated layers in the PCB. Individual conductive layers of the windings can be electrically connected together in the PCB using vias, to form multiple turns. Although the primary and secondary windings are illustrated in FIGS. 14A and 14B as continuous layers that encircle the legs of the core 820, the windings can be formed to have openings or breaks, and the conductive layers can be electrically connected together in the PCB using vias to form multiple turns of the windings. In the example shown, the first primary winding 850 and the second primary winding 855 each includes four turns. The first secondary winding 870 and the second secondary winding 875 each includes four turns. The turns of the primary and secondary windings are interleaved in the PCB, which can help to reduce leakage inductance between the primary and secondary windings and EMI issues. The coupling winding 880 includes two separate layers, and the windings 850, 855, 870, and 875 are positioned between the layers of the coupling winding 880.

The core 820 of the integrated transformer 800 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, the second core component 821A includes a first leg 830A, a second leg 830B, and an auxiliary leg 831. The primary and secondary windings of the integrated transformer 800 extend around the legs 830A and 830B. The coupling winding 880 extends around the auxiliary leg 831. The integrated transformer 800 can be mounted to a PCB and ends of the windings can be electrically coupled to traces on the PCB, consistent with the examples described herein.

In the example shown, the first leg 830A and the second leg 830B are cylindrical in shape. The auxiliary leg 831 is rectangular or cuboid in shape. The shapes of the first leg 830A, the second leg 830B, and the auxiliary leg 831 can vary as compared to that shown. For example, the first leg 830A and the second leg 830B can be formed in an elongated cylindrical shape, the auxiliary leg 831 can be formed in a cylindrical or elongated cylindrical shape, and other variations are within the scope of the embodiments. In the core 820, the auxiliary leg 831 forms an auxiliary pathway for magnetic flux, and the coupling winding 880 can be relied upon to magnetically couple another transformer similar to the transformer 800 based on the magnetic flux that flows through the auxiliary pathway in the auxiliary leg 831.

Turning to other examples, FIG. 15A illustrates an example of a planar integrated transformer 900 with a coupling winding according to various aspects of the present disclosure, and FIG. 15B illustrates an exploded view of the planar integrated transformer 900 shown in FIG. As one example, the integrated transformer 900 can be used in place of the integrated transformer 310 in the current doubler rectifier 300 shown in FIG. 7. As another example, the integrated transformer 900 can be used in place of the integrated transformer 510A or 510B in the current doubler rectifier 400 shown in FIG. 9. Additionally, two integrated transformers similar to the integrated transformer 900 can be used together, in place of each of the integrated transformers 510A and 510B.

Referring between FIGS. 15A and 15B, the integrated transformer 900 includes a core, including a first core component 920A and a second core component 921A (collectively “core 900”). The integrated transformer 900 also includes a first primary winding 950 and a second primary winding 955 (collectively “primary winding”). The integrated transformer 900 also includes a first secondary winding 970 and a second secondary winding 975 (collectively “secondary winding”). The integrated transformer 900 also includes a coupling winding 980.

If implemented with the current doubler rectifier 300 shown in FIG. 7, as one example, the first primary winding 950 in FIGS. 15A and 15B corresponds to the first primary winding P₁ shown in FIG. 7. The second primary winding 955 corresponds to the second primary winding P₂ shown in FIG. 7. The first secondary winding 970 in FIGS. 15A and 15B corresponds to the first secondary winding S₁ shown in FIG. 7. The second secondary winding 975 corresponds to the second secondary winding S₂ shown in FIG. 7. The coupling winding 980 in FIGS. 15A and 15B corresponds to a combination of the coupling windings C₁ and C₂ shown in FIG. 7.

The windings of the integrated transformer 900 can be embodied as conductive layers of metal (e.g., copper layers) in a PCB, separated by laminated layers in the PCB. Individual conductive layers of the windings can be electrically connected together in the PCB using vias, to form multiple turns. Although the primary and secondary windings are illustrated in FIGS. 15A and 15B as continuous layers that encircle the legs of the core 920, the windings can be formed to have openings or breaks, and the conductive layers can be electrically connected together in the PCB using vias to form multiple turns of the windings. In the example shown, the first primary winding 950 and the second primary winding 955 each includes four turns. The first secondary winding 970 and the second secondary winding 975 each includes four turns. The turns of the primary and secondary windings are interleaved in the PCB, which can help to reduce leakage inductance between the primary and secondary windings and EMI issues. The coupling winding 980 includes two separate layers, and the windings 950, 955, 970, and 975 are positioned between the layers of the coupling winding 980. As compared to the example shown in FIGS. 14A and 14B, the coupling winding 980 is formed as a semicircular winding, as the auxiliary leg of the core 920 is formed to have a different shape.

The core 920 of the integrated transformer 900 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, the second core component 921A includes a first leg 930A, a second leg 930B, and an auxiliary leg 931. The core 920 also includes side auxiliary legs 932A and 923B. The primary and secondary windings of the integrated transformer 900 extend around the legs 930A and 930B. The coupling winding 980 extends around the auxiliary leg 931. The integrated transformer 900 can be mounted to a PCB and ends of the windings can be electrically coupled to traces on the PCB, consistent with the examples described herein.

In the example shown, the first leg 930A and the second leg 930B are cylindrical in shape. The auxiliary leg 931 is formed as a semi-cylindrical shape. The shapes of the first leg 930A, the second leg 930B, and the auxiliary leg 931 can vary as compared to that shown. For example, the first leg 930A and the second leg 930B can be formed in an elongated cylindrical shape, the auxiliary leg 931 can be formed in a cylindrical or elongated cylindrical shape, and other variations are within the scope of the embodiments. In the core 920, the auxiliary leg 931 and the side auxiliary legs 932A and 923B form auxiliary pathways for magnetic flux. The coupling winding 980 can be relied upon to magnetically couple another transformer similar to the transformer 900 based on the magnetic flux that flows through the auxiliary pathway in the auxiliary leg 931. The side auxiliary legs 932A and 923B can be helpful to reduce core loss in the core 920, among other benefits.

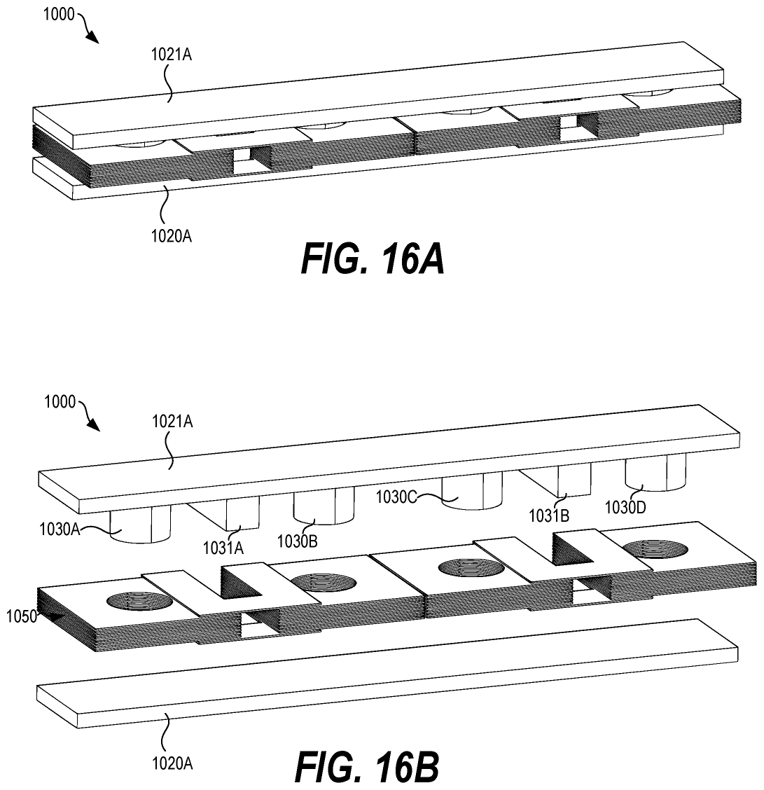

The integrated transformer shown in FIGS. 14A and 14B can be extended for the purpose of multiphase current doubler rectifiers. The integrated transformer shown in FIGS. 15A and 15B can also be extended for the purpose multiphase current doubler rectifiers. For example, FIG. 16A illustrates a planar integrated transformer 1000 with a coupling winding, and FIG. 16B illustrates an exploded view of the integrated transformer shown in FIG. 16B. The integrated transformer 1000 is similar to the integrated transformer 800 shown in FIGS. 14A and 14B but has been extended to use with multiphase current doubler rectifiers, such as the current doubler rectifier 400 shown in FIG. 9.

Referring between FIGS. 16A and 16B, the integrated transformer 1000 includes a core, including a first core component 1020A and a second core component 1021A (collectively “core 1020”). The integrated transformer 1000 also includes windings 1050, including primary, secondary, and coupling windings. If implemented with the current doubler rectifier 400 shown in FIG. 9, as one example, the windings 1050 include windings corresponding to the primary windings P₁, P₂, P₃, and P₄ shown in FIG. 9, consistent with the examples described herein. The windings 1050 also include windings corresponding to the secondary windings S₁, S₂, S₃, and S₄ shown in FIG. 9, consistent with the examples described herein. The windings 1050 also include windings corresponding to the coupling windings C₁, C₂, C₃, and C₄ shown in FIG. 9, consistent with the examples described herein.

The windings 1050 of the integrated transformer 1000 can be embodied as conductive layers of metal (e.g., copper layers) in a PCB, separated by laminated layers in the PCB. Individual conductive layers of the windings can be electrically connected together in the PCB using vias, to form multiple turns. Although the primary and secondary windings are illustrated in FIGS. 16A and 16B as continuous layers that encircle the legs of the core 1020, the windings can be formed to have openings or breaks, and the conductive layers can be electrically connected together in the PCB using vias to form multiple turns of the windings. The turns of the primary and secondary windings are interleaved in the PCB, which can help to reduce leakage inductance between the primary and secondary windings and EMI issues. The coupling winding includes layers, and the primary and secondary windings are positioned between the layers of the coupling winding.

The core 1020 of the integrated transformer 1000 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, the second core component 1021A includes legs 1030A-1030D, and auxiliary legs 1031A and 1031B. The primary and secondary windings of the integrated transformer 1000 extend around the legs 1030A-1030D. The coupling winding extends around the auxiliary legs 1031A and 1031B. The integrated transformer 800 can be mounted to a PCB and ends of the windings can be electrically coupled to traces on the PCB, consistent with the examples described herein. Additionally, the shapes and sizes of the legs can vary as compared to that shown.

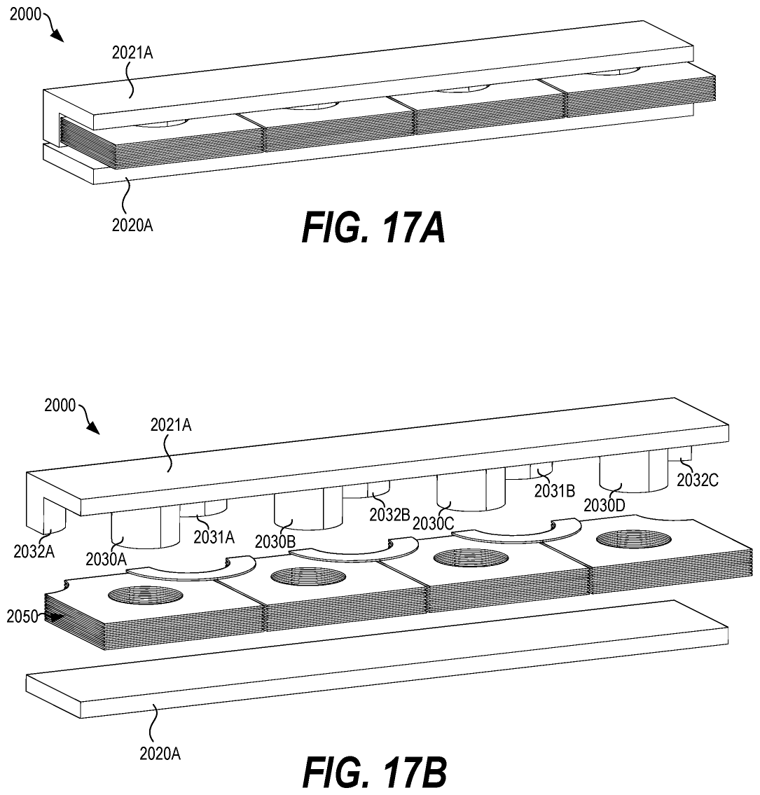

FIG. 17A illustrates a planar integrated transformer 2000 with a coupling winding, and FIG. 17B illustrates an exploded view of the integrated transformer shown in FIG. 17B. The integrated transformer 2000 is similar to the integrated transformer 900 shown in FIGS. 15A and 15B but has been extended to use with multiphase current doubler rectifiers, such as the current doubler rectifier 400 shown in FIG. 9.

Referring between FIGS. 17A and 17B, the integrated transformer 2000 includes a core, including a first core component 2020A and a second core component 2021A (collectively “core 2020”). The integrated transformer 2000 also includes windings 2050, including primary, secondary, and coupling windings. If implemented with the current doubler rectifier 400 shown in FIG. 9, as one example, the windings 2050 include windings corresponding to the primary windings P₁, P₂, P₃, and P₄ shown in FIG. 9, consistent with the examples described herein. The windings 2050 also include windings corresponding to the secondary windings S₁, S₂, S₃, and S₄ shown in FIG. 9, consistent with the examples described herein. The windings 2050 also include windings corresponding to the coupling windings C₁, C₂, C₃, and C₄ shown in FIG. 9, consistent with the examples described herein.

The windings 2050 of the integrated transformer 2000 can be embodied as conductive layers of metal (e.g., copper layers) in a PCB, separated by laminated layers in the PCB. Individual conductive layers of the windings can be electrically connected together in the PCB using vias, to form multiple turns. Although the primary and secondary windings are illustrated in FIGS. 17A and 17B as continuous layers that encircle the legs of the core 2020, the windings can be formed to have openings or breaks, and the conductive layers can be electrically connected together in the PCB using vias to form multiple turns of the windings. The turns of the primary and secondary windings are interleaved in the PCB, which can help to reduce leakage inductance between the primary and secondary windings and EMI issues. The coupling winding includes layers, and the primary and secondary windings are positioned between the layers of the coupling winding.

The core 2020 of the integrated transformer 2000 can be embodied as a material of high magnetic permeability, such as a ferromagnetic material like iron, laminated silicon steel, laminated iron sheets, or other solid or laminated ferromagnetic ceramic, metal, metal alloy, or related material(s). In the example shown, the second core component 2021A includes legs 2030A-2030D, auxiliary legs 2031A and 2031B. The core 2020 also includes side auxiliary legs 2032A-2023C. The primary and secondary windings of the integrated transformer 2000 extend around the legs 2030A-2030D. The coupling winding extends around the auxiliary legs 2031A and 2031B. The integrated transformer 1000 can be mounted to a PCB and ends of the windings can be electrically coupled to traces on the PCB, consistent with the examples described herein. Additionally, the shapes and sizes of the legs can vary as compared to that shown. The side auxiliary legs 2032A-2023C can be helpful to reduce core loss in the core 2020, among other benefits.

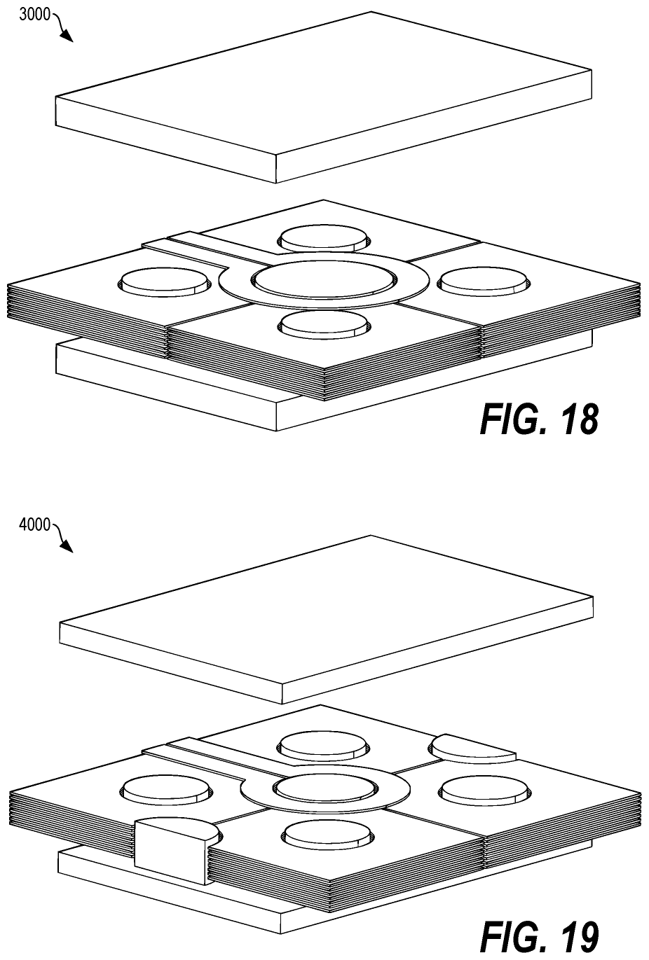

The integrated transformers shown in FIGS. 16A, 16B, 17A, and 17B can be implemented on other ways or in other form factors. As examples, FIG. 18 illustrates a planar integrated transformer 3000 with a coupling winding according to various aspects of the present disclosure. FIG. 19 illustrates another example of a planar integrated transformer 400 with a coupling winding according to various aspects of the present disclosure. Both the integrated transformers 3000 and 4000 are similar to the integrated transformer 2000 shown in FIGS. 17A and 17B, but are formed in a square form factor rather than a rectangular form factor. The integrated transformer 4000 also includes side auxiliary legs, which can be helpful to reduce core loss in some cases.

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. A power converter, comprising:
a switched bridged input stage; and
a current doubler rectifier output stage comprising an integrated transformer, wherein:
the integrated transformer comprises a plurality of magnetic cores;
a primary winding and a secondary winding of the integrated transformer extend around each of the plurality of magnetic cores; and
the integrated transformer further comprises a coupling winding that extends around each of the plurality of magnetic cores to provide magnetic integration among the plurality of magnetic cores through an electrical coupling.

2. The power converter according to claim 1, wherein:
each of the plurality of magnetic cores comprises side legs and a center leg;
the primary winding and the secondary winding of the current doubler rectifier output stage extend around the center leg of each of the plurality of magnetic cores.

3. The power converter according to claim 1, wherein:
each of the plurality of magnetic cores comprises side legs and a center leg;
the coupling winding extends around the center leg of each of the plurality of magnetic cores.

4. The power converter according to claim 1, wherein:
each of the plurality of magnetic cores comprises side legs and a center leg;
the primary winding and the secondary winding of the current doubler rectifier output stage extend around the side legs of each of the plurality of magnetic cores.

5. The power converter according to claim 4, wherein the coupling winding extends around the center leg of each of the plurality of magnetic cores.

6. The power converter according to claim 1, further comprising a coupling inductor electrically coupled with the coupling winding to set a coupling coefficient among the plurality of magnetic cores.

7. The power converter according to claim 1, wherein:
the primary winding comprises multiple turns extending around each of the plurality of magnetic cores;
the secondary winding comprises a plurality of winding fins;
each of the plurality of winding fins extending a single turn around each of the plurality of magnetic cores; and
the plurality of winding fins of the secondary winding are interleaved among the multiple turns of the primary winding around each of the plurality of magnetic cores.

8. The power converter according to claim 1, wherein:
the current doubler rectifier output stage comprises a plurality of output phases;
a first primary winding and a first secondary winding of a first of the plurality of output phases extend around two of the plurality of magnetic cores; and
a second primary winding and a second secondary winding of a second of the plurality of output phases extend around another two of the plurality of magnetic cores.

9. The power converter according to claim 1, wherein each of the plurality of magnetic cores comprises side legs and a center leg.

10. The power converter according to claim 9, wherein each of the plurality of magnetic cores comprises an air gap between the side legs and no air gap between the center leg.

11. The power converter according to claim 9, wherein each of the plurality of magnetic cores comprises an air gap between the center leg and no air gap between the side legs.

12. The power converter according to claim 1, wherein the integrated transformer comprises a planar transformer.

13. The power converter according to claim 1, wherein magnetization inductances in the integrated transformer operate as inductors in the current doubler rectifier output stage.

14. The power converter according to claim 1, wherein the current doubler rectifier output stage does not include inductors separated from the integrated transformer.

15. A current doubler rectifier, comprising:
an integrated transformer; and
a coupling inductor; wherein:
the integrated transformer comprises a magnetic core;
a primary winding and a secondary winding of the integrated transformer extend around legs of the magnetic core;
the integrated transformer further comprises a coupling winding that extends around auxiliary legs of the magnetic core; and
the coupling inductor is electrically coupled with the coupling winding to set a coupling coefficient among the legs of the magnetic core.

16. The current doubler rectifier according to claim 15, wherein:
the integrated transformer comprises a planar transformer; and
the auxiliary legs of the magnetic core comprise central auxiliary legs and side auxiliary legs.

17. The current doubler rectifier according to claim 16, wherein the coupling winding extends around each auxiliary leg among the auxiliary legs of the magnetic core.

18. A power converter, comprising:
a switched bridged input stage; and
a current doubler rectifier output stage, the current doubler rectifier output stage comprising an integrated transformer, wherein:
the integrated transformer comprises a magnetic core;
the magnetic core comprises two twisted central legs; and
a primary winding and a secondary winding of the integrated transformer extend around the two twisted central legs.

19. The power converter according to claim 18, wherein:
the primary winding comprises multiple turns extending around each of the two twisted central legs;
the secondary winding comprises a plurality of winding fins;
each of the plurality of winding fins extending a single turn around each of the two twisted central legs; and
the plurality of winding fins of the secondary winding are interleaved among the multiple turns of the primary winding around each of the two twisted central legs.

20. The power converter according to claim 18, wherein:
the current doubler rectifier output stage comprises a plurality of output phases;
the magnetic core comprises four twisted central legs; and
primary and secondary windings of a first output phase among the plurality of output phases of the current doubler rectifier output stage extend around two twisted central legs of the four twisted central legs; and
primary and secondary windings of a second output phase among the plurality of output phases of the current doubler rectifier output stage extend around another two twisted central legs of the four twisted central legs.
